(19) United States
(12) Patent Application Publication
(10) Pub. No.: US 2026/0334448 A1
(43) Pub. Date: Oct. 29, 2026

(54) CENTRALIZED PEST CONTROL SYSTEM WITH DISTRIBUTED LANDSCAPE FIXTURES

(71) Applicant: Sean O'Reilly, Tequesta, FL (US)

(72) Inventor: Sean O'Reilly, Tequesta, FL (US)

(21) Appl. No.: 19/658,187

(22) Filed: Apr. 24, 2026

Related U.S. Application Data
(60) Provisional application No. 63/795,862, filed on Apr. 28, 2025.

(51) Int. Cl. A01M 1/02; A01M 1/08

(52) U.S. Cl. CPC A01M 1/023; A01M 1/08

(57) ABSTRACT

A centralized pest control and landscape lighting system is disclosed. The system includes a central equipment cabinet housing an attractant tank, gas propellant source, low voltage transformer, induction fan, and a centralized pest collection container. A plurality of landscape fixtures are distributed across an outdoor environment, each fixture comprising a lighting element, at least one of a UV light or heating element, an emitter for dispensing aerosol attractants, and a suction port. The fixtures are operatively connected to the central cabinet via a network of suction lines and multi-channel conduits that simultaneously deliver vacuum flow, power, and attractant. The centralized collection container isolates pest remains from the fixtures and minimizes required servicing. A remote controller enables coordinated operation of lighting, heating, suction, and emission functions. The system provides improved pest attraction, streamlined maintenance, and reduced component redundancy over conventional decentralized pest control devices.

### REFERENCE TO RELATED APPLICATIONS

This application is a United States non-provisional patent application which claims the benefit of the filing date of U.S. Provisional Application Ser. No. 63/795,862 titled “CENTRALIZED PEST CONTROL SYSTEM WITH DISTRIBUTED LANDSCAPE FIXTURES” and filed 28 Apr. 2025 and the subject matter of which is incorporated herein by reference.

### CROSS-REFERENCES

Not applicable.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISK

Not applicable.

### TECHNICAL FIELD

The present disclosure relates to the field of pest management systems, and more specifically to the field of integrated pest control systems that incorporate centralized control architectures for managing a network of distributed outdoor fixtures configured for both landscape illumination and nuisance pest attraction, emission, and collection.

### BACKGROUND OF THE INVENTION

Conventional outdoor nuisance pest control systems, including those designed for mosquito mitigation, have historically relied on a decentralized deployment model. In such systems, each trap or fixture is typically a self-contained unit comprising its own power source, pest attractant mechanism, suction or collection component, and sometimes a localized storage container for captured pests. While this design allows for modular deployment, it introduces several significant limitations in terms of efficiency, cost, maintenance, and scalability.

One of the primary drawbacks of non-centralized pest control systems is the redundancy of components. Each independent unit often requires its own fan, power circuitry, control logic, and potentially even its own chemical or CO₂ supply for pest attraction. This redundancy inflates both manufacturing costs and long-term operational expenses, especially when deploying multiple units across large landscapes. Moreover, the presence of multiple power-consuming fans and heaters distributed throughout a property can lead to inefficient energy use.

Maintenance poses another critical challenge in existing non-centralized systems. Since each trap houses its own pest collection mechanism and attractant delivery components, routine servicing, such as emptying traps, refilling attractants, or diagnosing mechanical failures, must be carried out at each individual unit. This fragmented maintenance process increases labor time and complexity, particularly in installations with numerous fixtures spread across a wide perimeter or irregular terrain.

From a control standpoint, decentralized systems often lack integrated operational coordination. Most prior art devices operate independently, with limited or no centralized automation or synchronized triggering of lights, emitters, or fans. This isolated functioning can result in suboptimal pest attraction patterns and inefficient use of resources, especially when pest behavior or environmental conditions demand adaptive system-wide responses.

Additionally, the absence of a centralized collection mechanism leads to scattered and potentially incomplete trapping results. In systems with individual collection bins, pests are retained at the site of each trap, requiring the user to monitor and service multiple locations. This also introduces the risk of odor accumulation or contamination at each unit, particularly in warm climates where decomposition can occur rapidly.

Lastly, installation and system expansion in traditional non-centralized solutions can be cumbersome. Adding new traps often necessitates separate electrical hookups, calibration, and attractant loading, rather than allowing for plug-and-play scalability through a central infrastructure.

As a result, there exists a need for improvements over the prior art and more particularly for a pest control system that leverages a centralized architecture to reduce component redundancy, streamline maintenance, improve operational coordination, and enhance efficiency across distributed outdoor environments.

### BRIEF SUMMARY OF THE INVENTION

A system and method for a landscape nuisance pest control system are disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a landscape nuisance pest control system is disclosed. The system comprises a container configured to receive and retain nuisance pests, a first tank comprising a gas for attracting pests, a first air mover, a first location housing the container the first tank and the first air mover, a landscape fixture located at a second location disparate from the first location, and each of the landscape fixture and the first tank the second tank and the first air mover in communication by a plurality of conduits. The first location further houses a second tank comprising a mixture for attracting pests, the first tank in fluid communication with the second tank. A processor located at the first location monitors and controls operations of the landscape nuisance pest control system based on input received from at least one of a plurality of sensors disposed throughout the landscape nuisance pest control system. The landscape fixture comprises a mounting base comprising an electrical connection a pneumatic connection and a protective intake screen configured to permit ingress of target pests while restricting passage of non target debris, a suction port disposed on the landscape fixture and in communication with the container via a first conduit of the plurality of conduits, a lighting element configured to provide illumination, at least one of a second light element and a heating element configured to attract nuisance pests, an emitter in communication with at least one of the first tank and the second tank by a second conduit of the plurality of conduits the emitter configured to dispense an aerosol attractant mixture originating from the first location, and a first sensor of the plurality of sensors the first sensor configured to provide a signal to the processor. The first conduit comprises a second air mover for assisting suction from the landscape fixture to the container. The first location further comprises a power supply element in electrical communication with the landscape fixture and at least one of the first tank the second tank and the first air mover. The gas comprises carbon dioxide. The first air mover comprises an induction fan. The processor collects operational and environmental data from the plurality of sensors analyzes the collected data using training data stored in a memory determines a range of operational parameters for at least one of the first tank the second tank the first air mover and the landscape fixture to reduce a mosquito presence within a monitored area automatically deploys the landscape nuisance pest control system according to the determined range of operational parameters and updates the training data based on performance feedback derived from subsequently collected sensor data.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the disclosure and together with the description, explain the principles of the disclosed embodiments. The embodiments illustrated herein are presently preferred, it being understood, however, that the disclosure is not limited to the precise arrangements and instrumentalities shown, wherein:

FIG. 1 is a schematic diagram of a centralized pest control system with distributed landscape fixtures, showing the interconnection between the central equipment cabinet and an example landscape fixture, according to an example embodiment;

FIG. 2 is an operating environment of a perimeter layout illustrating the deployment of multiple landscape fixtures connected to a central equipment cabinet, each covering a defined area of pest attraction, according to an example embodiment;

FIG. 3A is an exploded perspective view of a landscape fixture assembly illustrating the modular components including the lighting element, heating and UV elements, emitter, intake screen, and mounting base, according to an example embodiment;

FIG. 3B is an assembled perspective view of the landscape fixture assembly, according to an example embodiment;

FIG. 4 illustrates a fixture mounting base design to interface with a suction line, according to an example embodiment;

FIG. 5 is a flowchart diagram illustrating a method for attracting and collecting nuisance pests using a centralized system and distributed fixtures, according to an example embodiment;

FIG. 6 is a flowchart diagram illustrating a method of controlling pests, according to an example embodiment;

FIG. 7 is a flowchart diagram illustrating a method of controlling pests using adaptive system control, according to an example embodiment;

FIG. 8 is a flowchart diagram illustrating a method of controlling pests using sensor-based pest detection and adaptive system control, according to an example embodiment;

FIG. 9 is a flowchart diagram illustrating a method of controlling pests using predictive pest behavioral analysis, according to an example embodiment, according to an example embodiment;

FIG. 10 is a flowchart diagram illustrating a method of controlling pests using scheduled attractant deployment and container monitoring, according to an example embodiment; and

FIG. 11 is a block diagram of a system including an example computing device and other computing devices, according to an example embodiment.

FIG. 12 illustrates a portion of the landscape nuisance pest control system configured to reduce bycatch of non-target insects and to maintain airflow through the system, according to an example embodiment.

Like reference numerals refer to like parts throughout the various views of the drawings.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions, or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing a system that utilizes a centralized control architecture to manage a network of distributed, multifunctional landscape fixtures. Unlike traditional decentralized pest traps that operate independently and require individual maintenance and power supply, the disclosed system enables centralized dispensing of attractants, coordinated lighting and pest attraction functions, and unified suction and collection through a common infrastructure. A central equipment cabinet houses core operational components, including an attractant tank, gas propellant system, low voltage transformer, and an integrated pest collection container, thereby consolidating key functions into a single location for streamlined maintenance and enhanced operational efficiency.

Importantly, the centralized collection container minimizes the frequency and complexity of service events by aggregating pest debris away from the distributed fixtures. This not only reduces user exposure to pest remains during routine landscape maintenance, but also helps preserve the aesthetic and functional integrity of the fixtures themselves. The distributed fixtures are configured to receive electrical power, pneumatic attractants, and suction via integrated multi-channel conduits, enabling easy deployment and synchronized activation. Each fixture combines lighting elements with UV or heating components, along with an emitter and a screened intake port optimized for pest entry while excluding debris. The system's coordinated, scalable design addresses the redundancy, inefficiency, and maintenance burdens of prior art systems, delivering improved performance, cleaner fixtures, and a significantly reduced operational footprint.

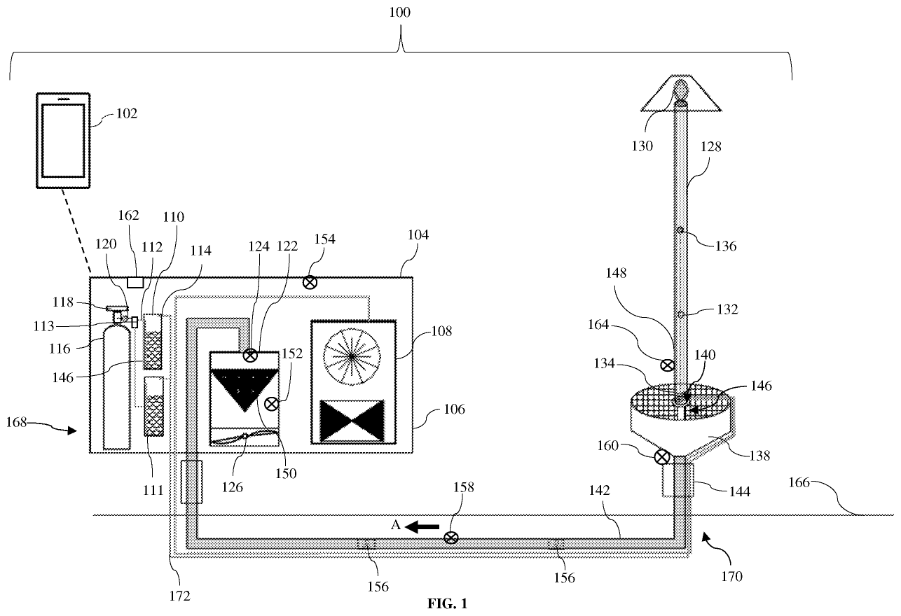

Referring now to FIGS. 1 through 4, a landscape lighting and nuisance pest control system 100 is illustrated and described. As shown throughout the figures, the system 100 includes a centralized equipment cabinet 104 operably coupled to a plurality of distributed landscape fixtures 128. The cabinet 104 is disposed in a first location 168 while the landscape fixtures 128 are disposed in a second location 170. The system further includes a remote controller 102 and is designed to simultaneously provide aesthetic outdoor lighting and pest mitigation across a deployment zone. The components are configured to operate in coordination through shared electrical, pneumatic, and suction infrastructure.

With reference to FIG. 1, the remote controller 102 generally refers to a device configured to send operational commands to both the central equipment cabinet 104 and the landscape fixtures 128. In one example embodiment, the remote controller 102 may be a handheld RF or infrared transmitter, a wireless touchscreen device, or a smartphone interface connected via Bluetooth, ZigBee, or Wi-Fi protocol. The remote controller enables the user to activate, deactivate, and selectively adjust individual or group functions, including lighting, heat or UV emission, suction, and aerosol dispersion. Such programmability permits dynamic adjustments based on ambient conditions, seasonal behavior of pests, or user preference, a significant advantage over fixed, autonomous traps of the prior art.

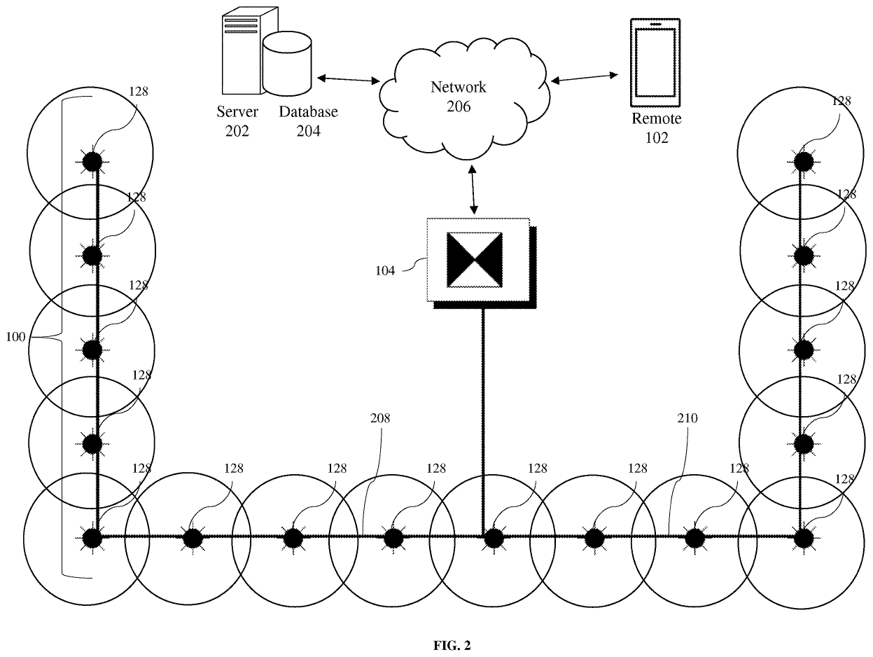

The central equipment cabinet 104, also shown in FIG. 1 and diagrammatically in FIG. 2, serves as the core mechanical and control enclosure. The cabinet comprises a weatherproof housing 106, which protects internal components from environmental exposure. The housing 106 may be fabricated from outdoor-rated powder-coated steel, polycarbonate composite, or other corrosion-resistant material. Inside the cabinet resides a low voltage transformer 108, which converts AC line voltage to a lower voltage suitable for outdoor electronics and lighting (typically 12V or 24V). The transformer 108 powers the suction fan, the electronically controlled valves, heating and lighting elements, and various sensors or control logic as required. Centralizing the power source within the cabinet reduces wiring complexity and increases safety, while enabling integrated circuit protection and monitoring.

The cabinet further houses a refillable and sealed attractant tank 110, which functions to hold a pest-attracting liquid composition. The tank 110, or second tank, comprises an inlet 112 for receiving compressed gas from an adjacent gas propellant tank 116, and an outlet 114 through which the attractant exits in aerosolized form. In one embodiment, the attractant tank is pressurized using carbon dioxide (CO₂), although alternative gases such as nitrogen or air may be employed. The regulator 118 modulates pressure between the propellant tank and attractant tank inlet to maintain consistent delivery, and an electronically controlled valve 120 governs when the gas is introduced. These components cooperate to produce a finely atomized attractant cloud when activated. Optionally, a heating element 150 may be positioned proximate to the attractant tank to elevate the temperature of the fluid mixture, facilitating aerosolization and enhancing vapor behavior under cooler ambient conditions.

In some embodiments, the second tank 110 includes a mixture including a plurality of ingredients configured to attract hematophagous pests. Generally, hematophagous pests are organisms that feed on blood, such as mosquitos, biting flies, midges, or other blood-feeding insects. Such pests locate hosts by detecting a combination of chemical cues associated with animal or human presence, including metabolic byproducts, skin-derived compounds, and other volatile organic compounds. A mixture configured to attract hematophagous pests therefore includes compounds that simulate or replicate chemical signatures commonly emitted by living hosts. More specifically, the second tank may store a liquid attractant mixture comprising a plurality of ingredients that produce chemical cues associated with host-seeking behavior in hematophagous insects. In one example embodiment, the mixture may include compounds such as lactic acid, ammonia, octenol, fatty acids, aldehydes, or other volatile organic compounds that mimic odors naturally emitted by mammals or humans. In one embodiment, the mixture may be a mixture of lactic acid and ammonia. When combined with the propellant gas supplied from the first tank, the mixture may be aerosolized and delivered through the conduit network to one or more landscape fixtures, where the mixture is emitted into the surrounding environment to attract hematophagous pests toward the landscape fixture.

In one example embodiment, the mixture contained within the second tank may include a combination of lactic acid and ammonia in selected ratios configured to mimic chemical signatures associated with human or animal body odors. Generally, lactic acid and ammonia are compounds commonly present in human perspiration and metabolic emissions, and combinations of these compounds may produce olfactory cues that are detectable by hematophagous pests. By varying relative concentrations of lactic acid and ammonia, the mixture may be configured to simulate different intensities or characteristics of host-derived odors. More specifically, in certain embodiments, the mixture may comprise lactic acid and ammonia in a ratio ranging from approximately 1:1 to 10:1 by weight or volume, such that lactic acid is present in a greater proportion relative to ammonia. In other embodiments, the ratio may be within a narrower range, such as approximately 2:1 to 5:1, which may correspond to compositions that approximate human skin emission profiles under moderate activity conditions. In further embodiments, the mixture may include lower concentrations of ammonia relative to lactic acid, such as ratios greater than 10:1, to provide a more subtle ammonia component while maintaining a dominant lactic acid signature.

In certain embodiments, alternative ratios may be employed depending on environmental conditions or target pest species. For example, higher relative concentrations of ammonia may be utilized in ratios approaching 1:1 or greater ammonia content in order to simulate stronger metabolic or waste-related cues associated with certain host conditions. Conversely, lower ammonia concentrations may be used to produce a milder attractant profile. The selected ratio may be adjusted dynamically by the processor or may be predefined within the mixture formulation stored in the second tank. The combination of lactic acid and ammonia within the selected ratio interacts with the propellant gas and the emitter of the landscape fixture to produce an aerosol attractant mixture that disperses into the surrounding environment. The emitted mixture presents a chemical profile that may be recognized by hematophagous pests as indicative of a potential host, thereby increasing the likelihood that such pests will approach the landscape fixture. By providing selectable or predefined ratios of lactic acid to ammonia, the system enables generation of attractant mixtures that more closely resemble natural host odors under varying conditions. This allows the landscape nuisance pest control system to tailor attractant profiles to different environmental scenarios, pest behaviors, or deployment strategies while maintaining centralized control of attractant composition.

The mixture contained within the second tank interacts with other components of the landscape nuisance pest control system, including the propellant gas source, the conduits, and the emitter of the landscape fixture. During operation, propellant gas from the first tank may pass through or otherwise entrain the attractant mixture contained within the second tank, forming an aerosol attractant mixture that is transported through the conduit network and released at the landscape fixture. The emitted mixture cooperates with other attractant elements of the landscape fixture, such as lighting elements or heating elements, to simulate host presence and encourage hematophagous pests to approach the fixture.

In one example embodiment, the second tank may be manufactured as a sealed or refillable reservoir configured to store the attractant mixture in liquid form. The tank may include an inlet configured to receive propellant gas and an outlet configured to permit the mixture or aerosolized attractant to exit the tank. The tank may be formed from polymeric materials, corrosion-resistant metals, or composite materials capable of containing chemical attractant formulations and withstanding pressurization associated with aerosol generation. By storing a mixture comprising multiple host-mimicking ingredients, the second tank allows the system to generate chemical signals that more closely resemble those produced by natural hosts. The use of a plurality of attractant ingredients allows the emitted attractant mixture to stimulate multiple sensory pathways used by hematophagous pests when locating hosts, thereby increasing the likelihood that such pests will orient toward the landscape fixture and be drawn into the airflow pathway leading to the container.

In some embodiments, the centralized cabinet in the first location includes a third tank 111. The third tank includes a mixture including a plurality of ingredients configured to attract oviposition-seeking pests. Generally, oviposition-seeking pests are insects that are searching for suitable locations to deposit eggs. Many nuisance insects, including certain mosquito species, rely on chemical and environmental cues associated with standing water, organic matter, and microbial activity when identifying locations appropriate for egg deposition. A mixture configured to attract oviposition-seeking pests therefore includes compounds that simulate environmental conditions typically associated with breeding or egg-laying sites. More specifically, the third tank may store a liquid attractant mixture comprising a plurality of ingredients that generate chemical cues associated with oviposition behavior. In one example embodiment, the mixture may include organic compounds, fermentation byproducts, fatty acids, indoles, phenolic compounds, or other volatile organic compounds that mimic odors produced by stagnant water or decomposing organic material commonly present in mosquito breeding environments. When combined with the propellant gas supplied from the first tank, the mixture may be aerosolized and conveyed through the conduit network to one or more landscape fixtures, where the mixture is emitted into the surrounding environment to attract oviposition-seeking pests.

The mixture contained within the third tank interacts with other components of the landscape nuisance pest control system, including the propellant gas source, the conduits, and the emitter associated with the landscape fixture. During operation, propellant gas from the first tank may pass through or otherwise entrain the attractant mixture stored within the third tank to generate an aerosol attractant mixture. The aerosolized mixture is transported through the conduit network and emitted at the landscape fixture, where the chemical cues encourage oviposition-seeking pests to approach the fixture. As the pests approach the fixture, airflow generated within the conduit network may draw the pests into the system for transport toward the container.

In one example embodiment, the third tank may be manufactured as a sealed or refillable reservoir configured to contain the oviposition attractant mixture. The tank may include an inlet configured to receive propellant gas and an outlet configured to permit the mixture or aerosolized attractant to exit the tank. The tank may be formed from polymeric materials, corrosion-resistant metals, or composite materials capable of containing attractant formulations and maintaining fluid integrity during system operation. By storing a mixture comprising ingredients that replicate chemical cues associated with breeding environments, the third tank enables the landscape nuisance pest control system to attract pests that are actively seeking oviposition sites. The presence of a separate attractant mixture configured for oviposition-seeking pests allows the system to target different behavioral states of nuisance insects and thereby expand the range of pests that may be attracted toward the landscape fixture and subsequently captured within the system.

In one example embodiment, the first tank, the second tank, the third tank, and the plurality of landscape fixtures are in fluid communication via conduits, such as conduit 172, configured to transport propellant gas and aerosol attractant mixtures throughout the landscape nuisance pest control system. Generally, fluid communication may be defined as a configuration in which fluid, including gas, liquid, or aerosolized mixtures, is permitted to flow between components through one or more interconnected pathways. The conduits define such pathways and enable controlled movement of fluids between the tanks located at the first location and the landscape fixtures positioned at disparate locations.

More specifically, the first tank comprising the propellant gas is connected by one or more conduits to the second tank and the third tank such that the propellant gas may be selectively directed into either tank. The second tank and the third tank are each further connected to conduits extending toward one or more landscape fixtures. In operation, propellant gas from the first tank flows through a selected one of the second tank or the third tank, where the gas entrains or mixes with an attractant mixture contained therein to form an aerosol attractant mixture. The resulting aerosol mixture is then conveyed through one or more conduits to the landscape fixtures, where the mixture is emitted into the surrounding environment. In this manner, the conduits establish fluid communication between the tanks and the landscape fixtures for delivery of attractant mixtures. The conduits may incluyde different types of fluid transport structures selected based on the type of fluid being conveyed and the operating conditions of the system. In one example embodiment, the conduits may comprise flexible tubing formed from polymeric materials such as polyethylene, polyurethane, polyvinyl chloride, or silicone, which may be suitable for routing below ground and accommodating landscape contours. In another example embodiment, portions of the conduit network may comprise rigid piping formed from materials such as PVC, CPVC, metal tubing, or composite piping to provide structural support and maintain consistent internal diameters for controlled flow. For gas transport, conduits may be configured to withstand pressurized flow conditions associated with the propellant gas, while conduits carrying aerosol mixtures may be configured to minimize condensation or deposition of attractant materials along interior surfaces.

In certain embodiments, the conduit network may include sealed fittings, couplings, manifolds, or junctions that interconnect different conduit segments and maintain fluid-tight connections between system components. The conduits may also include internal surface treatments or coatings configured to reduce frictional losses or prevent buildup of attractant residues. Additionally, conduit diameters, lengths, and routing paths may be selected to support desired flow rates and pressure characteristics associated with delivery of propellant gas and aerosol attractant mixtures to the landscape fixtures. The conduits interact with the tanks and the landscape fixtures to provide a continuous fluid pathway for transporting fluids throughout the system. By establishing fluid communication between the first tank, the second tank, the third tank, and the landscape fixtures, the conduit network enables centralized generation of attractant mixtures and distributed emission of such mixtures at multiple locations within the monitored area. This configuration allows the system to deliver attractants efficiently across a landscape while maintaining centralized storage and control of the fluid components.

In one example embodiment, switching between the second tank mixture and the third tank mixture may be accomplished by a valve assembly 113 disposed along a propellant gas flow path upstream of the second tank and the third tank. In this configuration, the first tank provides propellant gas to a selector manifold having a first branch line coupled to the inlet of the second tank and a second branch line coupled to the inlet of the third tank. A controllable valve arrangement selectively establishes fluid communication between the propellant gas source and one of the branch lines such that propellant gas is drawn through the selected tank to entrain and aerosolize the corresponding mixture. The valve arrangement may comprise a three-way solenoid valve, a pair of two-way solenoid valves operated in a mutually exclusive manner, or a rotary diverter valve that aligns an internal passage with the selected branch. In operation, the processor outputs a control signal to energize a solenoid or actuator to open the branch associated with the desired tank while closing the other branch, thereby automatically switching fluid communication of the propellant gas between the second tank and the third tank.

In another example embodiment, switching may be performed on an attractant outlet side rather than the propellant inlet side. In this configuration, the second tank and the third tank each provide an outlet coupled to a downstream manifold leading to the conduit that supplies the emitter at the landscape fixture. A valve block selectively couples the manifold to one outlet at a time so that only one mixture is delivered to the conduit. The valve block may include electrically actuated poppet valves, diaphragm valves, or pinch valves, and may be configured as a selector valve with a common outlet and multiple inlets. The processor controls the selector valve to connect the common outlet to the second tank outlet during a hematophagous-attraction mode and to connect the common outlet to the third tank outlet during an oviposition-attraction mode.

In one example embodiment, the switching mechanism further includes isolation features to inhibit backflow and cross-contamination between mixtures. For example, check valves may be disposed in each branch line so that pressure transients or downstream suction do not cause mixture from one tank to migrate toward the other tank. Additionally, the system may implement a purge or clearing routine during switching in which the processor temporarily closes both branches and actuates the propellant gas through a purge line or through the selected branch for a defined interval to clear residual mixture from a shared manifold segment prior to emission at the landscape fixture. In this manner, the system can more cleanly transition between the second tank mixture and the third tank mixture while maintaining predictable composition of the aerosol attractant mixture delivered to the emitter.

In one example embodiment, the valve assembly may be packaged as a compact manifold module at the first location adjacent the tanks and coupled to the conduit network by sealed fittings. The manifold module may be formed from corrosion-resistant metals or chemical-resistant polymers and may include O-ring sealed ports, barbed fittings, compression fittings, or quick-connect couplers compatible with pressurized gas and aerosolized attractant flow. Electrical actuation may be provided by a low-voltage solenoid coil or a motor-driven actuator controlled by the processor through a driver circuit. This arrangement enables automated, repeatable switching between attractant modes based on sensor-derived inputs and processor-determined pest behavioral state.

In one example embodiment, the regulator 118 further includes a timing control circuit configured to regulate the timing and duration of propellant gas delivery from the propellant tank 116 to the attractant tank 110. The timing control circuit may comprise a low-voltage timer module, such as a 9-volt timer, configured to automatically activate the regulator during predetermined intervals corresponding to periods of increased mosquito activity. For example, the timer may be programmed to enable operation for approximately two-hour intervals at dusk and at dawn, which are commonly associated with heightened mosquito host-seeking behavior. During these activation intervals, the regulator 118 maintains a controlled pressure and flow rate of the propellant gas delivered to the inlet 112 of the attractant tank 110. In one embodiment, the regulator is configured to maintain the carbon dioxide flow at approximately five pounds per square inch (5 PSI), which has been determined to provide an effective balance between stable aerosol generation and realistic atmospheric dispersion. At this pressure level, the emitted carbon dioxide plume approximates the respiration output of a human host, thereby enhancing the biological realism of the attractant signal and increasing the likelihood that nearby mosquitos will orient toward the emitted attractant cloud. By controlling both the timing and pressure characteristics of the propellant gas, the regulator 118 contributes to efficient attractant deployment while conserving propellant and attractant resources.

In another embodiment, the attractant tank may be configured to accept a chemical mixture (e.g., vinegar and baking soda) that generates internal pressure through chemical reaction. This design provides an alternative to the propellant tank and enables passive generation of positive pressure, reducing reliance on compressed gas canisters in lower-maintenance environments.

Captured pests are directed to a collection container 122 disposed within the cabinet 104. The collection container is in fluid communication with an induction fan 126, which, when activated, creates negative pressure throughout the connected suction network. At the top of the collection container, a valve 124, which may be electronically actuated, gravity-assisted, or spring-loaded, automatically closes when suction is discontinued. The valve 124 seals the pest remains inside the container, containing odor, preventing pest escape, and eliminating the need to service individual fixtures. This central collection scheme significantly reduces the user burden and health hazards associated with decentralized traps.

The system 100 includes the collection container 122 disposed within the central equipment cabinet 104 and configured to serve as the primary receptacle for storing pests drawn through the network of suction lines 142. The collection container 122 is operably coupled downstream of the induction fan 126 and functions as the terminal destination for all nuisance pests attracted, captured, and transported from the plurality of landscape fixtures 128. Its design is critical not only to the containment of pests but also to the hygiene, maintenance, and long-term operability of the system as a whole.

The collection container 122 may be structured as a rigid, sealed canister, tray, or cartridge, fabricated from corrosion-resistant and easily washable materials such as stainless steel, molded high-density polyethylene (HDPE), or UV-stabilized ABS polymer. In certain embodiments, the container may be removable from the cabinet via a slide-out drawer, hinged panel, or lift-out basket to facilitate periodic servicing. The container may be formed with smooth interior walls to prevent the accumulation of debris and to permit rapid cleaning and reinstallation during maintenance operations.

To ensure secure retention of pests, the container 122 is equipped with a top-mounted valve 124 that automatically seals the intake opening when the induction fan 126 is inactive. The valve 124 may be implemented as an electronically actuated butterfly valve, a spring-assisted flap, or a gravity-controlled gate, depending on power availability and environmental requirements. During system operation, the fan generates negative pressure, drawing the valve open to admit air and entrained pests into the container. Upon fan deactivation, the valve automatically returns to its closed position, sealing the contents and preventing escape, odor emission, or backflow through the suction network. This configuration enables the system to operate hygienically and securely, even in warm or humid environments where decomposition and pest escape pose practical concerns.

The container 122 may also include ventilation or desiccation features, such as integrated screens, odor-filtering membranes, or silica packets, to manage moisture levels and suppress odors between service intervals. In certain embodiments, a transparent or translucent viewing panel may be integrated into the container wall or lid to permit visual inspection of fill level without disassembly. Alternatively, a capacitive, weight-based, or optical sensor may be included to detect pest accumulation and provide a signal to the controller for service alerts or operation adjustment.

In one embodiment, the collection container 122 may be further configured to receive and support a removable collection bag or disposable liner to facilitate hygienic handling and simplified maintenance. The collection bag may be composed of flexible polymeric film, biodegradable material, or odor-controlling fabric, and is structured to conform to the internal geometry of the container. The use of a removable bag enables the user to extract and dispose of accumulated pests without direct contact with the internal surfaces of the container itself. In certain implementations, the bag may include integrated drawstrings, elastic sealing rings, or snap-fit collars that engage corresponding retention features within the container to ensure a secure fit during operation. The removable bag may be pre-treated with a desiccant, insecticide, or odor-absorbing material to suppress decomposition and neutralize offensive odors. This bagging system permits rapid and sanitary servicing of the collection unit and eliminates the need for intensive cleaning after each maintenance cycle, thereby enhancing the usability of the system and reducing the user's exposure to biohazardous materials.

The placement of the collection container within the central cabinet, rather than at each individual fixture, represents a key improvement over traditional pest control systems. In the prior art, pest remains are typically retained within each trap, requiring the user to access and clean multiple decentralized units. In contrast, the present system centralizes all pest accumulation into a single, easily accessible location, dramatically reducing user labor, minimizing contact with biohazards, and preserving the aesthetic and functional integrity of the fixtures. This architectural decision also facilitates the use of more powerful and efficient suction mechanisms, since the system no longer requires size-constrained fans or collectors at each fixture.

Furthermore, the central location of the collection container allows integration with automated containment enhancements, including internal bagging systems, odor control inserts, and programmable closure logic, all of which would be impractical to deploy across multiple outdoor trap sites. In sum, the collection container 122 is not merely a passive receptacle but a core operational component whose configuration and placement yield substantial gains in hygiene, convenience, system reliability, and user experience.

The induction fan 126 housed within the central equipment cabinet may be configured as a variable-speed unit, as indicated in the diagram and documents. In one embodiment, the fan may be a brushless DC centrifugal blower coupled to a speed controller that adjusts airflow output based on system demands, time of day, pest pressure, or user-defined schedules. For example, the fan may ramp up to maximum flow during peak insect activity periods (e.g., dusk and dawn), and operate at reduced capacity during transitional periods to conserve power or minimize noise. In advanced embodiments, the system may include sensors to detect airflow blockage, suction loss, or pest density, and dynamically adjust the fan speed to optimize performance. A variable-speed fan also supports reversibility, allowing the system to flush or purge the suction network during cleaning cycles initiated via the flush port. This represents a marked improvement over fixed-speed fan architectures in standalone traps, offering adaptive, programmable airflow management across a distributed network of fixtures.

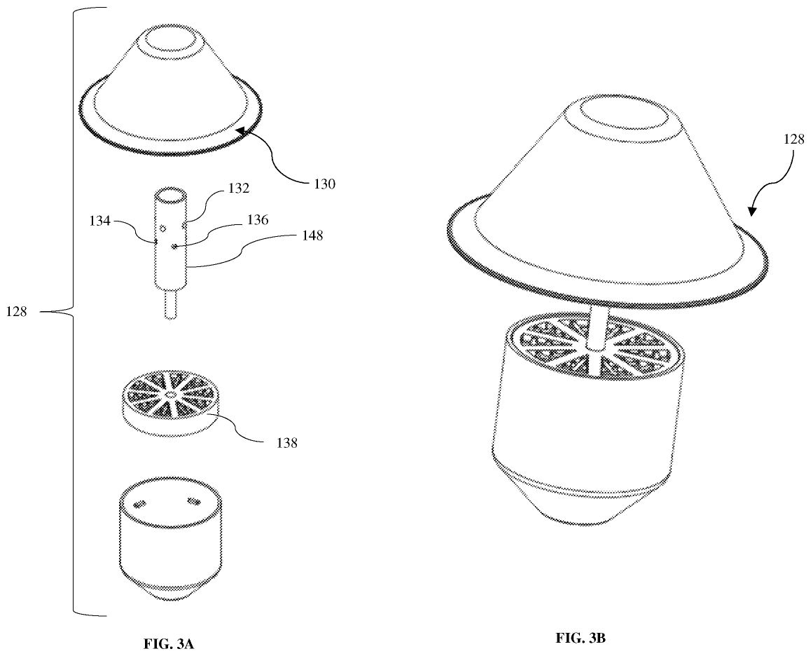

A plurality of landscape fixtures 128 are distributed across the outdoor area, each connected to the central cabinet via a network of suction lines 142. As best shown in FIGS. 2, 3A, and 3B, each fixture 128 includes a lighting element 130, such as an LED or halogen source, which provides ambient or accent lighting. The lighting element is powered by the central transformer and may be controlled manually or according to schedule via the remote controller 102.

In one or more embodiments, the system 100 includes the network of suction lines 142, or conduits, that operatively connect the suction port or ingress 140 of each landscape fixture 128 to the induction fan 126 and collection container 122 housed within the central equipment cabinet 104. The suction lines form a pneumatic conduit system through which air and entrained pests are conveyed under negative pressure, enabling centralized capture and containment. The network may be arranged in a branching, looped, or hub-and-spoke configuration, depending on the landscape geometry, fixture distribution, and required suction balancing.

Each suction line may be formed of flexible or rigid tubing, such as outdoor-rated thermoplastic elastomer (TPE), polyethylene, corrugated PVC, or reinforced rubber, and may include quick-connect couplings or compression fittings to facilitate modular assembly and maintenance. In certain embodiments, the suction lines are configured as multi-channel conduits, where a single bundled structure contains three independent pathways: (i) a vacuum channel for air and pest transport, (ii) an electrical power line for delivering low voltage power to each fixture, and (iii) a pneumatic line for distributing aerosolized attractant from the attractant tank 110 to the emitter 136. These conduits may be jacketed in a weather-resistant sheath and may be color-coded or keyed for proper alignment during installation.

In one embodiment, the network of suction lines 142 is configured as a system of multi-functional conduits that not only serve as pneumatic pathways for vacuum flow but also house integrated electrical wiring and, where applicable, pneumatic or fluid lines for delivery of the aerosol attractant. Each conduit may be formed as a bundled or jacketed assembly comprising an inner vacuum channel, adjacent low-voltage electrical conductors, and a pressurized delivery tube for carrying attractant from the centralized tank 110 to each fixture-mounted emitter 136. The electrical conductors within the conduit deliver regulated low-voltage power, which originates from the low voltage transformer 108 within the central equipment cabinet 104, to support operation of the lighting element 130, UV light element 132, heating element 134, and any electronic control devices integrated into each fixture 128. By consolidating these electrical and pneumatic functions into a single, unified conduit network, the system eliminates the need for separate wiring paths or local power supplies at each fixture location. This architectural approach simplifies installation, reduces material costs, and ensures that all system functionality, including power delivery, suction, and attractant distribution, originates from and is managed by the centralized cabinet, thereby enhancing serviceability, reliability, and overall system integration.

The plurality of conduits 142 extending between the first location and the landscape fixture may be positioned below the ground 166 within the landscape. Placement of the conduits beneath a ground surface allows the conduit network to remain substantially concealed from view while connecting distributed landscape fixtures with the central components housed at the first location. Subsurface routing of the conduits reduces visual disruption within the landscape and allows the landscape fixtures to appear similar to conventional landscape lighting or decorative elements. By concealing the conduits below ground, the system may be integrated into residential yards, commercial properties, parks, or other landscaped environments without introducing visible tubing or mechanical infrastructure. This configuration promotes aesthetic compatibility with the surrounding landscape while allowing the pest control system to operate across distributed locations within the monitored area.

The conduit 142 includes at least one second air mover 156 for assisting suction from the landscape fixture to the container. The second air mover may be a device configured to impart motion to air to induce airflow in direction A within a fluid pathway. Air movers of this type are commonly used in pneumatic and ventilation systems to create pressure differentials that cause air to move from one location to another. The second air mover may include any mechanical or electromechanical apparatus capable of producing airflow, including fan assemblies, blowers, turbine devices, or other rotary airflow-generating mechanisms. More specifically, in the landscape nuisance pest control system described herein, the second air mover is disposed within the first conduit extending between the landscape fixture located at the second location and the container positioned at the first location. The second air mover is configured to assist suction from the landscape fixture toward the container by increasing airflow within the first conduit. In one example embodiment, the second air mover may include an inline fan positioned along an intermediate portion of the conduit so that airflow generated within the conduit assists movement of air and entrained pests from the landscape fixture toward the container.

The second air mover may be similar to a booster fan disposed between the first location 168 and second location 170 (or other locations where the fixtures may be dispersed within an area) and operates in cooperation with other components of the system, including the landscape fixture, the conduit network, and the first air mover located at the first location. During operation, pests attracted to the landscape fixture enter an intake region of the fixture where airflow is directed into the first conduit. The second air mover increases the velocity or volume of air traveling through the conduit, thereby assisting transport of air and nuisance pests through the conduit toward the container. In certain embodiments, the second air mover may operate simultaneously with the first air mover to maintain a desired airflow rate throughout the conduit network. In one example embodiment, the second air mover may be manufactured as a compact inline fan assembly comprising a housing, an electric motor, and one or more fan blades mounted to a rotating shaft of the motor. The housing may be configured to couple with the conduit such that airflow produced by the fan is directed along the conduit interior. The housing may be formed from molded polymeric materials, corrosion-resistant metals, or composite materials suitable for outdoor environments. Electrical wiring for the motor may extend along the conduit or through a protective conduit sheath to connect with a power supply located at the first location. By positioning an additional air mover within the conduit, the system is capable of maintaining airflow across extended conduit distances or through conduit networks that include bends, elevation changes, or other flow restrictions. This configuration assists in transporting nuisance pests from the landscape fixture to the container while supporting distributed placement of landscape fixtures within a monitored area.

In some embodiments, the second air mover may include a variable speed fan configured to generate airflow within the first conduit. Generally, a variable speed fan is an airflow-generating device in which the rotational speed of a fan motor may be adjusted in order to vary the volume or velocity of air moving through a conduit. Such devices may include electronically controlled motors that permit modulation of airflow output based on received control signals. More specifically, the second air mover may be disposed within the first conduit extending between the landscape fixture and the container and may be configured to assist suction from the landscape fixture toward the container. In one example embodiment, the second air mover comprises a variable speed booster fan positioned along the conduit so as to increase airflow through the conduit network. Operation of the second air mover may be regulated by the processor based on signals received from one or more sensors disposed throughout the landscape nuisance pest control system. For example, sensors positioned at the landscape fixture, within the conduit, or at the container may provide signals corresponding to airflow conditions, pest activity levels, environmental conditions, or other operational parameters. The processor may process the sensor signals and adjust the rotational speed of the variable speed fan to increase or decrease airflow within the conduit.

The second air mover interacts with the processor and a sensor 158, configured to detect airflow speed, to dynamically regulate airflow through the conduit network. In one example embodiment, the processor generates control signals that modulate the operating speed of the second air mover in response to detected pest density, airflow measurements, or environmental conditions. In other embodiments, the second air mover may include a sensor detecting a plurality of parameters associated with the air mover. By adjusting the operating speed of the booster fan, the system may maintain a desired airflow rate through the conduit while assisting movement of air and entrained nuisance pests from the landscape fixture toward the container.

In one example embodiment, the variable speed fan may be manufactured as an inline fan assembly including a housing, an electric motor capable of variable rotational speeds, and a plurality of fan blades mounted to a rotating shaft of the motor. The housing may be configured to couple directly with the conduit such that airflow generated by the fan is directed along the interior of the conduit. The housing and fan components may be formed from polymeric materials, corrosion-resistant metals, or composite materials suitable for outdoor environmental conditions.

By allowing the airflow generated within the conduit to be selectively adjusted, the variable speed second air mover enables the landscape nuisance pest control system to regulate suction conditions within the conduit network. This configuration facilitates consistent transport of nuisance pests from the landscape fixture to the container while accommodating changes in conduit length, environmental conditions, or pest activity detected by the sensors.

Proximal to each fixture, a proportioning valve 144 may be included to regulate suction intensity or isolate individual units. This allows compensation for variable line lengths and elevations and facilitates zone-based optimization. In flat terrains, the suction network may follow shallow subgrade paths or be mounted along retaining walls, while in sloped or terraced landscapes, the lines may be routed with consideration to gravity and airflow direction to maintain efficient draw. In some embodiments, the lines may be trenched beneath turf, integrated with irrigation conduits, or concealed within architectural hardscape features.

The placement of landscape fixtures 128 across the deployment zone is highly adaptable and may be customized to accommodate aesthetic preferences, pest behavior, and topographical constraints. In one embodiment, fixtures are spaced at regular intervals along the perimeter of a property to establish a protective boundary zone that intercepts incoming pests before they reach human-occupied areas. This perimeter deployment strategy is particularly effective in warm climates or near wetlands, where pest ingress tends to follow predictable paths. It should be noted that each of the fixtures may be in disparate locations while still having a central collection area for the pests at the first location 168.

In another embodiment, fixtures are installed in a radial configuration surrounding a central area such as a patio, pool, or garden. Here, the placement creates concentric rings of attractant zones and provides both localized lighting and a draw-away effect, encouraging pests to congregate near the fixtures and away from occupants. Alternatively, fixtures may be deployed in a clustered arrangement at high-risk zones such as near water features, compost bins, or dense vegetation, where pest activity is concentrated.

Each fixture may be mounted directly into soil using a threaded stem 148 and receptacle 146 at the base, or may be surface-mounted to decking, masonry, or concrete using brackets or integrated pedestals. Depending on the embodiment, fixtures may also be installed in recessed housings, wall sconces, or bollards, provided that airflow to the suction port and projection of attractant cues remain unobstructed.

By supporting diverse placement strategies and flexible pneumatic connectivity, the system accommodates a wide range of residential, commercial, and public landscape designs. The centralized suction infrastructure, when combined with modular fixture deployment, provides consistent pest mitigation performance while maintaining ease of installation, low-profile appearance, and long-term serviceability.

Each fixture further includes at least one of a UV light element 132 or a heating element 134. The UV element emits in the 365-400 nm range, which is highly attractive to mosquitoes and other phototropic insects. The heating element emits infrared thermal energy and simulates body heat, further increasing the attraction for blood-seeking pests such as mosquitoes and gnats. These elements may be selectively or concurrently activated, depending on pest behavior or environmental conditions. The controller 102 may independently modulate intensity, duty cycle, or activation duration per fixture or group of fixtures, providing precise control over attractant presentation.

Proximate to these attractant mechanisms is an emitter 136, which is in communication with the outlet 114 of the attractant tank. The emitter is structured to release the aerosol mixture into the surrounding air volume, typically as a fine mist near the intake region of the fixture. This strategic placement maximizes the probability that pests drawn by UV or heat will encounter the chemical attractant and be lured toward the suction intake.

Each fixture includes a mounting base 138, which provides both physical support and functional integration. The base houses electrical connectors, pneumatic lines, and a protective intake screen that is dimensioned to allow ingress of target pests while excluding debris and larger animals. In one embodiment, the base further comprises a threaded receptacle 146 configured to receive a threaded stem 148 for anchoring the fixture into the ground or mounting surface.

A suction port 140 is formed within each fixture and is pneumatically linked to the induction fan via the network of suction lines. These lines, in one embodiment, are configured as multi-channel conduits capable of simultaneously carrying vacuum airflow, electrical power, and attractant fluid to each fixture. This integration streamlines installation and reduces clutter typically associated with conventional systems. Proportioning valves 144 may be included proximate to each fixture to balance flow characteristics or isolate a fixture for maintenance. Each landscape fixture 128 may further include a gate-style proportioning valve, positioned immediately downstream or upstream of the suction port 140, as shown in the system diagram. The gate-style valve is structured to permit precise control of airflow to or from each fixture, allowing installers or automated controllers to balance the vacuum flow rate (CFM) across fixtures of varying lengths from the central cabinet. In larger installations with uneven line lengths, fixtures closer to the cabinet may otherwise draw disproportionately more airflow. By incorporating localized flow control using these proportioning valves, the system ensures even suction across all active ports, improving pest draw efficiency and allowing targeted trapping. The valves may include visual position indicators and may be adjustable manually or electronically depending on configuration.

The network of suction lines may further include a gate-style proportioning valve, positioned immediately downstream or upstream of the suction port. The gate-style valve is structured to permit precise control of airflow to or from each fixture, allowing installers or automated controllers to balance the vacuum flow rate (CFM) across fixtures of varying lengths from the central cabinet. In larger installations with uneven line lengths, fixtures closer to the cabinet may otherwise draw disproportionately more airflow. By incorporating localized flow control using these proportioning valves, the system ensures even suction across all active ports, improving pest draw efficiency and allowing targeted trapping. The valves may include visual position indicators and may be adjustable manually or electronically depending on configuration.

In various embodiments, each landscape fixture 128 is equipped with the suction port 140 that is in fluid communication with the central equipment cabinet 104 via the network of suction lines 142. The suction port 140 defines the intake aperture through which ambient air, and any entrained nuisance pests, is drawn into the fixture during operation of the induction fan 126. The port 140 may be configured as a front-facing circular inlet, a screened lateral opening, or an upward-facing slot, depending on the fixture's overall form factor. The suction port is typically shielded by a protective intake screen integrated into the mounting base 138, which serves to admit flying pests of a target size while preventing the ingress of debris, plant matter, or non-target animals. The flow pathway downstream of the suction port is aerodynamically shaped to promote smooth airflow and minimize noise or turbulence.

The relative positioning of the heating element 134, UV light element 132, lighting element 130, and aerosol emitter 136 with respect to the suction port 140 may vary across different embodiments. In one example embodiment, the UV light element and heating element are disposed immediately adjacent to the suction port 140 such that pests drawn toward the thermal or photonic signature naturally position themselves near the intake region, thereby increasing the probability of capture. In this configuration, the aerosol emitter 136 is also positioned proximate to the suction port, such as above or to the side, so that the attractant vapor is concentrated within the capture zone. This clustered configuration creates a multi-modal attractant field, wherein pests are simultaneously exposed to visual, thermal, and chemical stimuli at or near the intake point.

In another embodiment, the UV light element 132 and/or heating element 134 may be offset from the suction port and oriented to project their respective attractant signals toward the intake region from a distance. For instance, the UV light may be mounted on an elevated stalk or lens housing and directed downward toward the base of the fixture, while the heating element may encircle the midsection of the fixture in a radiant band configuration. Similarly, the aerosol emitter 136 may be located along the perimeter of the fixture and designed to release vapor toward the intake zone via directional nozzles. Such spatial decoupling allows broader dispersion of attractant stimuli and may reduce crowding around the intake screen, thereby preserving airflow dynamics. This embodiment is particularly advantageous in ornamental fixtures where visual design or lighting functionality must be preserved.

In yet another embodiment, the UV light element, heating element, and emitter may be coaxially integrated with the suction port, such that the attractant sources form an annular or nested structure around the intake. For example, the UV emitter may be implemented as a circular ring light surrounding the port, while the heating element is embedded in the housing wall surrounding the intake. The aerosol emitter may be positioned to release a controlled mist across the intake flow path, ensuring that approaching pests are drawn directly into the airstream after exposure. This integrated configuration simplifies the overall geometry of the fixture and may improve manufacturability while providing precise control over the attractant zone.

The ability to vary the positional relationship of these elements across different embodiments allows system integrators or end users to optimize pest attraction and capture efficiency based on specific environmental, aesthetic, or performance considerations. Importantly, the system architecture and remote controller 102 support independent or coordinated activation of each attractant modality, regardless of its physical location within the fixture. As such, the system accommodates diverse fixture geometries while maintaining consistent suction-based pest removal to the centralized collection container.

Additional enhancements to the landscape lighting and pest control system 100 may include structural features configured to improve environmental resilience and long-term performance of the suction infrastructure. In one embodiment, a shroud is positioned adjacent to or integrated with the suction port 140 of each landscape fixture 128. The shroud may be formed as a partially enclosed cowl, louvered hood, or vented housing that extends outwardly from the fixture body to cover the intake region. The shroud is specifically configured to shield the suction port from external airflow disturbances such as crosswinds, gusts, or eddy currents that may otherwise interfere with the laminar draw of air into the port. By mitigating wind-induced turbulence, the shroud helps maintain consistent suction velocity and ensures that airborne pests attracted to the fixture are reliably drawn into the intake rather than deflected by ambient air currents. In certain embodiments, the shroud may also serve as a secondary debris barrier and may be fabricated from UV-stabilized polymer or powder-coated aluminum to withstand outdoor exposure.

In addition to shrouding, the system may incorporate one or more weep holes disposed along the network of suction lines 142, particularly at low points or terminal segments of the conduit pathways. A weep hole, in this context, refers to a small-diameter perforation or vent formed in the wall of the suction conduit, typically less than 2 mm in diameter, and optionally covered by a one-way membrane or filter media. The weep hole permits moisture drainage from within the conduit system, particularly in humid environments or where condensation may accumulate due to thermal cycling. Without such drainage, residual moisture may impair airflow, promote microbial growth, or contribute to internal corrosion or clogging. The weep hole may also function as a pressure equalization port, allowing ambient air to stabilize internal pressure differentials in the event of sudden fan stoppage or conduit obstruction. In some embodiments, the weep hole may be located at or near the fixture base and integrated into the mounting stem to allow moisture to pass directly into the soil or substrate.

Together, the shroud and weep hole features enhance the robustness and environmental tolerance of the suction system, particularly in outdoor applications subject to variable weather and debris conditions. These elements may be provided as standard or optional accessories depending on site-specific installation requirements. Importantly, they represent non-invasive, passive design elements that support long-term system functionality without requiring additional control circuitry or power.

In various embodiments, the system 100 may further include one or more heating elements strategically positioned to enhance the performance of specific subsystems, including the attractant tank 110, the collection container 122, and the suction ports 140 of the landscape fixtures 128. In one embodiment, a heating element 150 is disposed in thermal proximity to the attractant tank 110 to elevate the temperature of the contained attractant fluid. Heating the attractant reduces viscosity and increases volatility, thereby facilitating aerosolization and improving the diffusion characteristics of the attractant mixture as it is emitted through the fixture-mounted emitter 136. The heating element may be implemented as a resistive wrap heater, a flexible silicone heating pad, or an integrated cartridge heater, and may be controlled by a programmable timer or temperature sensor to maintain an optimal operating range. In another embodiment, a heating element may be installed adjacent to or integrated within the collection container 122 to mitigate condensation buildup, prevent freezing in cold climates, and reduce microbial growth by maintaining a dry and elevated internal temperature. This is particularly advantageous when the container includes removable collection bags or liners that may otherwise retain moisture. Additionally, heating elements may be positioned near or around the suction ports 140 within each landscape fixture to emit infrared radiation that mimics mammalian body heat. This thermal signature serves as an attractant, particularly for hematophagous insects such as mosquitoes, which are drawn to heat sources. These heating elements may be activated independently or in coordination with UV lights and aerosol emission based on programmed pest activity cycles. Collectively, the strategic placement of heating elements within the system not only enhances attractant efficacy and collection efficiency but also expands operational resilience across diverse environmental conditions.

The processor 162 is a computing device configured to receive data, execute programmed instructions, and generate control signals for operating components of a system. Processors of this type may include microprocessors, microcontrollers, embedded computing modules, programmable logic devices, or other electronic processing units capable of executing software instructions stored in memory. The processor may include associated memory elements, communication interfaces, and input/output circuitry that allow the processor to receive signals from sensors and transmit control commands to system components. More specifically, the processor is disposed at the first location and is configured to monitor and control operations of the landscape nuisance pest control system based on input received from at least one of a plurality of sensors disposed throughout the landscape nuisance pest control system. The sensors may be positioned at various locations including the landscape fixture, the conduit network, the container, and other components housed at the first location. Signals generated by the sensors may correspond to environmental conditions, pest activity, airflow characteristics, attractant deployment conditions, or other operational parameters. The processor receives the sensor signals and processes the received information to determine operational states or adjustments for system components.

The processor interacts with multiple components of the landscape nuisance pest control system in order to regulate system operation. For example, the processor may communicate with the first tank, the second tank, the first air mover, the second air mover, and the landscape fixture through electrical connections or communication interfaces. Based on signals received from the plurality of sensors, the processor may generate control signals that adjust operation of airflow devices, regulate movement of propellant gas or attractant mixtures, activate lighting or heating elements of the landscape fixture, or otherwise coordinate operation of system components to facilitate attraction and capture of nuisance pests.

In one example embodiment, the processor may be implemented as an embedded controller mounted within a protective housing at the first location. The processor may include a printed circuit board supporting an integrated circuit microcontroller, memory modules, power management circuitry, and communication interfaces. Electronic components may be enclosed within a sealed or weather-resistant enclosure formed from polymeric materials, metal housings, or composite materials suitable for outdoor environmental conditions. Electrical connections may extend between the processor and other system components through wiring harnesses, conduit-mounted cables, or wireless communication modules. The processor allows the landscape nuisance pest control system to operate in a coordinated and responsive manner by enabling centralized monitoring and control of distributed system components. Through reception and analysis of sensor signals, the processor facilitates automated system operation and allows the system to respond to changing environmental conditions and pest activity detected throughout the monitored landscape.

The landscape nuisance pest control system may further include sensor arrays 154 and 160 configured to monitor environmental conditions, pest activity, and operational parameters of the system. The sensor arrays 154 and 160 may be distributed throughout the system, including within the centralized cabinet, along the conduit network, and at one or more landscape fixtures. Each sensor of the sensor array may generate data corresponding to a particular condition, such as temperature, humidity, airflow, sunlight exposure, pest detections, or system performance characteristics. The sensors communicate with the processor so that the processor may receive and analyze sensor signals to monitor system operation and environmental conditions within the monitored area. By incorporating multiple sensors operating collectively as a sensor array, the system is capable of gathering data from different locations within the landscape nuisance pest control system and using the collected data to regulate system operation. The sensor array may also include other sensors in the present disclosure.

In some embodiments, the landscape nuisance pest control system further includes a solar sensor 164 configured to detect sunlight conditions within a monitored area. Generally, the solar sensor may be defined as a light-responsive sensing device configured to generate data corresponding to an amount of solar radiation, ambient light intensity, or sunlight exposure present at a particular location. The solar sensor may comprise any suitable photosensitive device capable of detecting changes in sunlight conditions over time, including photodiodes, photoresistors, photovoltaic sensing elements, irradiance sensors, or other optical detection components. More specifically, the solar sensor may be disposed at the landscape fixture, at the first location, or at another exposed location within the monitored area such that the solar sensor is capable of detecting sunlight conditions representative of the surrounding environment. The solar sensor is in communication with the processor and is configured to provide sensor signals corresponding to detected sunlight intensity, duration of daylight exposure, rate of change in ambient light, or transitions between daylight and dusk conditions. In one example embodiment, the processor receives data from the solar sensor and uses the detected sunlight conditions as an input for predicting periods of increased nuisance pest activity. For example, the processor may determine that decreasing sunlight intensity approaching dusk corresponds with an increased likelihood of mosquito host-seeking behavior and may thereby initiate or modify operation of the landscape nuisance pest control system.

The solar sensor interacts with the processor and other system components to support predictive and adaptive control of system operation. In one example embodiment, the processor may analyze solar sensor data together with additional environmental data, such as temperature, humidity, wind conditions, and pest detection data, to determine a predicted pest behavioral state or a predicted period of elevated pest presence. Based on this determination, the processor may control one or more operational parameters of the system, including activation of the first air mover, operation of the second air mover, emission timing of an aerosol attractant mixture, selection of an attractant source, or activation of a lighting element and/or a heating element associated with the landscape fixture. For example, the processor may increase attractant deployment during periods of declining sunlight at dusk, may reduce operation during periods of full daylight associated with reduced mosquito activity, or may initiate operation before sunset based on a predicted transition in pest behavior derived from sunlight trends detected by the solar sensor.

In one example embodiment, the processor may further store historical sunlight data in a memory and may correlate sunlight conditions with prior pest activity and prior attractant deployment performance. Through such analysis, the processor may learn recurring relationships between sunlight exposure and nuisance pest activity within the monitored area. For example, the processor may determine that particular sunlight levels, sunset transitions, shaded conditions, or combinations of sunlight and temperature correspond to increased populations of hematophagous pests or oviposition-seeking pests. Based on such determinations, the processor may predict when a monitored pest population is likely to enter a particular behavioral state and may automatically adjust operation of the system before pest density reaches a peak level.

In one example embodiment, the solar sensor may be manufactured as a compact weather-resistant sensing assembly including a photosensitive element, protective lens or transparent cover, electrical leads, and a housing configured for outdoor installation. The housing may be formed from polymeric materials, coated metals, or composite materials resistant to moisture, ultraviolet exposure, and temperature variation. The solar sensor may be mounted on the landscape fixture, on a support structure, or at another location selected to provide representative sunlight exposure, and may communicate with the processor through wired electrical connections or wireless communication circuitry.

By incorporating a solar sensor into the landscape nuisance pest control system, the system may more accurately predict time-based and environment-based changes in pest activity without relying solely on fixed schedules. Use of sunlight-derived data allows the processor to account for changing seasonal conditions, cloud cover, shade conditions, and variations in sunrise and sunset timing within the monitored area. In this manner, the solar sensor improves the ability of the system to anticipate nuisance pest behavior and to control attractant deployment and airflow operation in a manner responsive to actual environmental conditions.

In some embodiments, the plurality of sensors also includes a wing-beat frequency sensor 152 configured to detect a wing frequency of a mosquito and to generate data corresponding to a quantity of mosquitos based on detected wing frequency signatures. The wing-beat frequency sensor may generally be defined as a sensing device configured to detect periodic motion generated by insect wing movement and to produce data representative of the detected frequency. Wing-beat frequency sensors operate by detecting oscillatory signals generated as an insect moves wings during flight, where the oscillation rate corresponds to a characteristic frequency associated with a particular insect type. Many flying insects exhibit wing-beat frequencies within identifiable ranges, allowing detection systems to differentiate between insects based on measured frequency patterns. More specifically, the wing-beat frequency sensor is configured to detect a wing frequency of a mosquito and to generate data corresponding to a quantity of mosquitos based on detected wing frequency signatures. In one example embodiment, the sensor may be positioned at the landscape fixture, within an intake region of the landscape fixture, or along the conduit through which air and pests are transported. As mosquitoes fly through a sensing region associated with the sensor, the wing movement interrupts or modulates a sensing signal. The sensor detects this modulation and generates electrical signals corresponding to the detected wing-beat frequency. The generated signals are transmitted to the processor, where the processor may analyze the detected frequency signatures to determine whether the detected insect corresponds to a mosquito and may accumulate multiple detection events to estimate the quantity of mosquitos within the monitored area.

The wing-beat frequency sensor interacts with the processor and other components of the landscape nuisance pest control system to provide real-time pest detection data. In one example embodiment, the processor receives signals corresponding to detected wing-beat frequencies and compares the detected frequencies with stored frequency ranges associated with mosquito species. For example, mosquitoes typically exhibit wing-beat frequencies within a characteristic range that may differ from other insects present in the environment. When the detected frequency corresponds to a mosquito wing-beat signature, the processor may increment a detection count representing mosquito activity. Accumulated detections over time allow the processor to estimate a relative quantity of mosquitoes present within the monitored area.

In one example embodiment, the wing-beat frequency sensor may be implemented using optical detection components that generate a light beam across a sensing region. As a mosquito passes through the beam, wing movement intermittently interrupts the light path, producing periodic fluctuations in detected light intensity that correspond to the wing-beat frequency. In another example embodiment, the sensor may comprise an acoustic sensor configured to detect sound waves generated by insect wing movement. Additional embodiments may utilize laser-based optical sensors, infrared sensors, or other detection devices capable of sensing rapid oscillatory motion associated with insect flight. Sensor components may be mounted within a protective housing and may include signal conditioning circuitry for converting raw detection signals into electrical signals suitable for transmission to the processor.

By detecting characteristic wing-beat frequencies associated with mosquitoes, the wing-beat frequency sensor enables the landscape nuisance pest control system to monitor mosquito activity within the monitored area. The resulting detection data provides an indication of pest presence and pest density, allowing the processor to adjust operational parameters of the system in response to observed mosquito activity. This capability supports adaptive operation of attractant emission and airflow generation in order to enhance pest capture within the system.

In certain embodiments, the wing-beat frequency sensor may include a commercially available mosquito detection device, such as a BG-Counter sensor positioned within cabinet 104 of the system 100. A BG-Counter device is configured to detect insect wing-beat frequencies as insects enter the collection pathway, either the container 122 or the conduit 142 and to classify detections based on measured frequency characteristics associated with mosquito flight. The BG-Counter generates detection data corresponding to the number of mosquitos detected within the sensing region and may transmit the resulting data to the processor for analysis and storage. By positioning such a device within the cabinet near the container, mosquitos transported through the conduit network toward the container may pass through the sensing region where wing-beat signatures are detected and counted.

In one example embodiment, the landscape nuisance pest control system 100 may incorporate intelligent control components configured to monitor, automate, and optimize operation of system elements. Such intelligent control components may include network-enabled control devices, automation modules, or computing systems capable of receiving sensor data and generating control signals for connected devices. These systems may operate using programmed logic, rule-based automation, or machine learning algorithms to coordinate operation of airflow devices, attractant deployment systems, lighting elements, or other components of the pest control system. More specifically, in certain embodiments the system may incorporate automation devices manufactured by Shelly, such as network-enabled relay controllers, smart switches, or automation modules configured to control electrical devices within the system. Shelly devices may be installed within the cabinet at the first location and may be electrically connected to components including the first air mover, the second air mover, lighting elements of the landscape fixture, valves controlling attractant release, or other powered elements. These devices may communicate with the processor through wired or wireless communication protocols including Wi-Fi, local area network communication, or other network-based control interfaces. Through such communication, the processor may issue commands to activate or deactivate devices, regulate operating schedules, or adjust operational parameters of the system.

In certain embodiments, the processor may further implement artificial intelligence (AI) or other intelligent analysis systems configured to process data received from the plurality of sensors disposed throughout the landscape nuisance pest control system. The AI system may analyze environmental data, pest detection data, operational data, and historical system performance data in order to identify patterns associated with nuisance pest activity. For example, the system may evaluate variables such as temperature, humidity, sunlight levels, time of day, wind conditions, and detected wing-beat frequency signatures in order to determine when pest populations are likely to increase within the monitored area.

The intelligent control system may interact with various system components to enable adaptive operation of the landscape nuisance pest control system. In one example embodiment, the processor may use outputs from the AI system to automatically adjust operation of airflow devices, regulate attractant deployment timing, switch between different attractant mixtures, activate lighting or heating elements, or otherwise control components of the system in response to predicted pest activity. Such automated control may occur through direct processor commands or through network-enabled control modules such as the Shelly automation devices.

In one example embodiment, the intelligent control components may include memory storing historical operational data and training data associated with system performance. Machine learning algorithms executed by the processor may analyze stored data together with newly received sensor data in order to refine predictions relating to pest behavior and environmental conditions. Through repeated operation and data collection, the system may update internal models used to predict pest presence and adjust system operation accordingly.

By incorporating network-enabled automation devices and intelligent analysis systems, the landscape nuisance pest control system may coordinate operation of distributed components while responding to changing environmental conditions and pest activity levels detected within the monitored area. This configuration allows the system to dynamically regulate attractant deployment, airflow generation, and other system functions based on real-time and historical data associated with nuisance pest behavior.

In some embodiments, the landscape nuisance pest control system may further include an airflow sensor configured to measure airflow within the conduit network. The airflow sensor may include a hot wire probe anemometer configured to detect air velocity passing through a conduit. A hot wire probe anemometer operates by measuring changes in heat dissipation from a heated sensing element exposed to moving air, where the rate of heat loss corresponds to the velocity of airflow. The sensor may generate electrical signals corresponding to measured air velocity, which may then be converted into airflow measurements such as cubic feet per minute (CFM). More specifically, the hot wire probe anemometer may be positioned within the conduit network or within the cabinet near the airflow pathway leading to the container. As air and entrained pests move through the conduit, the airflow passes across the heated probe element of the anemometer. The sensor detects airflow velocity and generates data corresponding to the volume of air moving through the conduit, which may be expressed in CFM. The sensor communicates this airflow data to the processor, allowing the processor to monitor airflow conditions within the system. The airflow sensor interacts with the processor, valves, and air movers of the landscape nuisance pest control system to regulate airflow conditions. In one example embodiment, the processor receives airflow data from the hot wire probe anemometer and compares the measured airflow with predetermined airflow ranges associated with effective pest capture. Based on the measured CFM, the processor may adjust system components to maintain a desired airflow rate. For example, the processor may regulate valve positions associated with gas flow or attractant delivery, or may adjust operating speed of the first air mover or the second air mover.

In certain embodiments, the processor may adjust fan speed of the air movers in response to airflow measurements detected by the hot wire probe anemometer. Excessive airflow may increase system noise levels or may cause pests passing through the airflow pathway to be damaged or fragmented by rapidly rotating fan blades. Conversely, insufficient airflow may reduce the ability of the system to transport pests through the conduit network toward the container. By monitoring airflow in terms of CFM, the processor may adjust fan speed of the air movers to maintain airflow within a range that promotes effective transport of mosquitos through the conduit network while avoiding airflow conditions that are excessively loud or that may disrupt the integrity of captured insects.

In one example embodiment, the hot wire probe anemometer may be implemented as a compact sensor assembly including a heated sensing wire, signal conditioning circuitry, and a protective probe housing configured for installation within a conduit or airflow passage. The housing may be formed from corrosion-resistant materials suitable for outdoor environmental conditions. Electrical connections between the anemometer and the processor may allow continuous or periodic transmission of airflow data so that the processor can dynamically adjust system operation based on real-time airflow measurements. By monitoring airflow passing through the conduit network, the hot wire probe anemometer allows the system to regulate airflow conditions and adjust operation of airflow-generating devices to maintain an airflow range suitable for transporting mosquitos through the system while limiting noise and minimizing mechanical damage to the captured insects.

With reference to FIG. 2, a top plan view of an operating environment illustrating the deployment of multiple landscape fixtures connected to a central equipment cabinet, each covering a defined area of pest attraction, is shown, according to an example embodiment. The operating environment includes the server 202 associated with repository or database 204 and further coupled with network 206, which can be a circuit switched network, such as the Public Service Telephone Network (PSTN), or a packet switched network, such as the Internet or the World Wide Web, the global telephone network, a cellular network, a mobile communications network, or any combination of the above. In one embodiment, network 206 is a secure network wherein communications between endpoints are encrypted so as to ensure the security of the data being transmitted. Server 202 is a central controller or operator for the functionality that executes on at least a user remote device 102, via various methods.

FIG. 2 further shows that server 202 includes a database or repository 204, which may be one or more of a relational databases comprising a Structured Query Language (SQL) database stored in a SQL server, a columnar database, a document database and a graph database. Computing devices102 may also include its own database. The repository 204 serves data from a database, which is a repository for data used by server 202 and the mobile devices during the course of operation of the invention. Database 204 may be distributed over one or more nodes or locations that are connected via network 206.

FIG. 2 shows an embodiment wherein networked computing device 102 may interact with server 202 and repository 204 over the network 206. Server 202 includes a software engine that delivers applications, data, program code and other information to networked computing device 102. The software engine of server 202 may perform other processes such as audio and/or video streaming or other standards for transferring multimedia data in a stream of packets that are interpreted and rendered by a software application as the packets arrive. It should be noted that although FIG. 2 shows only one networked computing device 102, the system of the present invention supports any number of networked mobile computing devices connected via network 206, having at least the user remote device 202.

Server 202 also includes program logic comprising computer source code, scripting language code or interpreted language code that is compiled to produce executable file or computer instructions that perform various functions of the present invention. In another embodiment, the program logic may be distributed among more than one of server 202, computing device 102, or any combination of the above. Note that although server 202 is shown as a single and independent entity, in one embodiment of the present invention, the functions of server 202 may be integrated with another entity, such as computing device 102. Further, server 202 and its functionality, according to a preferred embodiment of the present invention, can be realized in a centralized fashion in one computer system or in a distributed fashion wherein different elements are spread across several interconnected computer systems.

The centralized cabinet 104 disposed at the first location is connected to the plurality of landscape fixtures 128 through a conduit network extending across the monitored landscape where such landscape fixtures are at a disparate location from the centralized location For example, the distance between the first location and second location may be greater than 10 feet, greater than twenty feet or even greater than thirty feet. The conduit network may include at least a first conduit 208 and a second conduit 210 leading to disparate locations. Each landscape fixture 128 is positioned at a disparate location relative to the centralized cabinet 104 and relative to other landscape fixtures 128, thereby forming a distributed arrangement of fixtures that collectively cover the monitored area. The fixtures may be arranged along a perimeter or boundary region of the monitored landscape so that the operational coverage regions of adjacent fixtures overlap. For example, fixtures may be positioned along the edges of a residential yard, along a fence line, around a patio area, along a garden perimeter, or around a recreational area so that nuisance pests entering the monitored area encounter one or more fixtures positioned nearby.

The centralized cabinet 104 interacts with the plurality of landscape fixtures 128 by providing airflow and attractant delivery through the conduit network extending between the cabinet and the fixtures. During operation, attractant mixtures generated within the centralized cabinet 104 may be conveyed through the conduit network to the respective landscape fixtures 128 where the attractant mixtures are emitted into the surrounding environment. For example, propellant gas and attractant mixtures stored within the cabinet may be directed through conduits extending beneath the ground surface toward each fixture, where an emitter releases the attractant mixture into the surrounding air. At the same time, airflow generated by air movers associated with the centralized cabinet 104 may create suction through the conduit network so that air and nuisance pests entering the landscape fixtures 128 are transported through the conduits toward the centralized cabinet 104. As pests approach the fixture in response to the attractant plume, airflow at the fixture intake may draw the pests into the conduit network, allowing the pests to be conveyed through the conduits toward the container housed within the cabinet.

Each of the landscape fixtures 128 operates within a corresponding operational region illustrated by the circular areas surrounding each fixture. The operational regions may partially overlap with adjacent operational regions so that a continuous coverage area is formed across the monitored landscape. By way of example, a fixture positioned near a corner of the monitored area may generate an attractant plume and airflow region extending outward from the fixture, while an adjacent fixture positioned several feet away may generate a similar region that partially overlaps the first region. This overlapping configuration helps ensure that pests present between two fixtures may still be influenced by at least one attractant plume and corresponding airflow region. In certain embodiments, the fixtures may be spaced at predetermined intervals selected based on landscape size, airflow capacity, and expected pest activity levels.

By positioning multiple fixtures 128 in this distributed arrangement, nuisance pests present in different portions of the landscape may be attracted toward the fixtures and drawn through the conduit network toward the centralized cabinet 104 for collection. For example, mosquitoes approaching from wooded areas, nearby water sources, vegetation, or shaded regions may encounter attractant plumes emitted from one or more fixtures positioned near those areas. The distributed configuration allows the system to intercept pests across a broad region rather than relying on a single collection location.

The centralized cabinet 104 may further communicate with external computing components through a network 206. The network 206 enables communication between the centralized cabinet 104, a server 202, a database 204, and a remote device 102. Through the network 206, operational data generated by the landscape fixtures 128 and other components of the system, such as sensors 152, 154, 158, 160, 164, fan or air mover 124, second air movers 156, 156, valves 113, 120, 124, 144, power supply 108, lighting element 130, pressure regulator 118, may be transmitted to the server 202 and stored within the database 204 in records associated with each of the device. For example, data relating to pest detections, airflow conditions, environmental sensor readings, attractant deployment timing, or system operating states may be transmitted to the server 202 and recorded within the database 204 for subsequent analysis within records.

The remote device 102 may access the server 202 through the network 206 in order to monitor system operation or provide control inputs that influence operation of the centralized cabinet 104 and the distributed landscape fixtures 128. For example, a user operating the remote device 102 may view system status information, review pest activity data, adjust operating schedules, initiate maintenance notifications, or modify operational parameters associated with the landscape nuisance pest control system. Communication between the remote device 102 and the centralized cabinet 104 through the network 206 may occur through wireless communication protocols, internet-based communication, or other network communication systems.

Through the interactions illustrated in FIG. 2, the centralized cabinet 104 coordinates operation of the distributed landscape fixtures 128 while maintaining communication with network-connected computing components. The arrangement allows attractant deployment, airflow generation, pest collection, and system monitoring to occur across multiple disparate locations within the monitored landscape while maintaining centralized control at cabinet 104. For example, the centralized cabinet 104 may simultaneously deliver attractant mixtures to several landscape fixtures, regulate airflow through multiple conduits, collect pests transported from different fixture locations, and communicate operational data to remote monitoring systems, thereby enabling coordinated operation of the landscape nuisance pest control system across the monitored area.

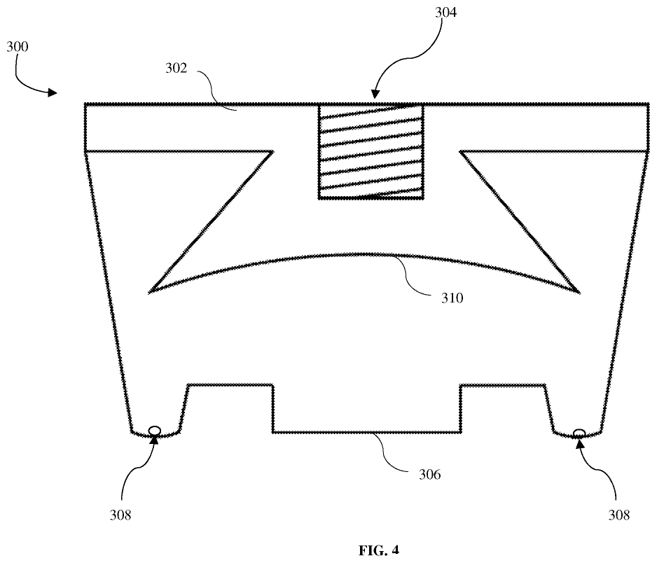

Referring now to FIG. 4, an example embodiment of a fixture mounting base designed to interface with the suction system and accommodate the structural stem of a landscape lighting fixture is shown. As shown, the mounting base 300 includes a removable cap 302 featuring a central threaded receptacle 304 or insert configured to receive the threaded stem of a landscape light fixture, such as those described in FIGS. 1 and 3. This threaded engagement enables easy installation and removal of the fixture, while also maintaining alignment between the internal electrical, pneumatic, and vacuum connections housed within the base.

The lower portion of the base is formed with a mounting flange 306 for the suction line, which permits secure coupling of the vacuum conduit leading from the central equipment cabinet 104. The flange may include locking tabs, compression fittings, or adhesive channels to support both above-ground and subgrade installation. In one embodiment, the suction connection may also include multi-channel functionality, supporting simultaneous conveyance of air, power, and attractant through a single conduit.

Additionally, FIG. 4 identifies a weep hole 308 location near the bottom edge of the fixture base. The weep hole is configured to allow for passive drainage of any moisture that may accumulate due to condensation, precipitation, or dew ingress within the base cavity. The weep hole may be formed as a small-diameter perforation or slotted opening and may include a screen, filter membrane, or one-way valve to prevent ingress of soil or insects. Placement of the weep hole at the lowest vertical point allows for gravitational egress of liquid, helping to preserve suction efficiency, protect electrical components from corrosion, and prevent biological growth within the base.

In one embodiment, the interior of the fixture base shown in FIG. 4 may further include an integrated shroud 310 or deflector surface that is structurally configured to channel accumulated moisture toward the designated weep hole location. The shroud may be formed as a sloped or contoured inner wall segment that encircles or underlies the central cavity of the base, thereby promoting directional flow of water due to gravity. This internal geometry is particularly beneficial in outdoor environments where condensation, irrigation spray, or rainfall may introduce small quantities of liquid into the base housing. Rather than allowing fluid to pool within the electrical and pneumatic connection zone, the shroud actively guides liquid away from sensitive components and toward the lowermost portion of the housing where the weep hole is positioned. In certain embodiments, the shroud may be integrally molded with the base during manufacturing, while in others it may be a separate insert or lining fabricated from hydrophobic plastic, corrosion-resistant metal, or elastomeric material. This passive drainage system not only preserves the performance and longevity of the fixture's internal components but also supports consistent suction flow by ensuring that the air pathway remains unobstructed by standing water.

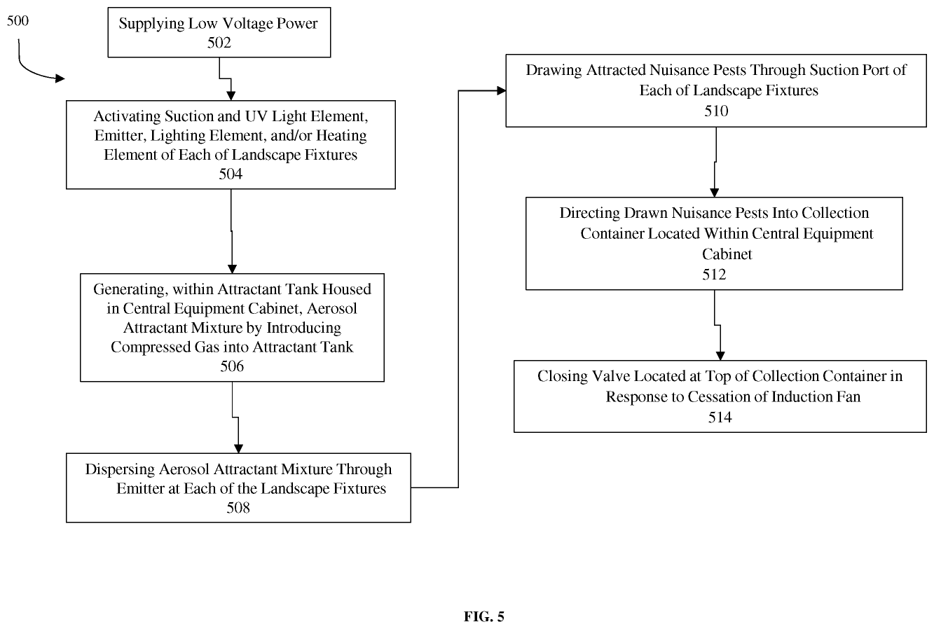

Referring now to FIG. 5, a method 500 for attracting and collecting nuisance pests using the described system is illustrated. At step 202, low-voltage power is supplied from the central equipment cabinet 104 to each of the distributed landscape fixtures 128. This includes electrical power necessary to operate lighting, UV elements, heating components, and electronic control interfaces.

In step 502, low voltage electrical power is supplied from the central equipment cabinet 104 to each of the plurality of landscape fixtures 128. This power is provided by the low voltage transformer 108 located within the weatherproof housing 106 of the cabinet. The transformer converts standard mains voltage (e.g., 120VAC or 240VAC) into a lower, safe output voltage (e.g., 12V or 24V) suitable for outdoor-rated lighting and electronic components. Power is distributed through multi-channel conduits incorporated into the suction network, such that a single physical pathway delivers electrical current to each fixture, along with pneumatic and vacuum lines. The system may be configured to remain energized in standby mode or may activate upon user initiation or a programmed timer.

At step 504, the user, through the remote controller 102, initiates one or more functional components of the system. These components may include the induction fan 126, the lighting element 130, the UV light element 132, the heating element 134, and the attractant emitter 136 within each landscape fixture 128. The controller may initiate all systems simultaneously, or may selectively activate only certain subsystems depending on ambient lighting, time of day, or pest activity levels. For instance, the UV light and heating elements may be ramped up during dusk hours when mosquitoes are most active. The system may further include programmable intensity control for the lighting and heat elements, permitting fine-grained adjustment for optimizing pest attraction while managing power consumption.

In step 506, the system generates an aerosol attractant mixture within the attractant tank 110. This is achieved by releasing compressed gas, such as CO₂ or air, from the gas propellant tank 116 through a pressure regulator 118 and an electronically controlled valve 120 into the sealed attractant tank. The gas enters the tank through inlet 112 and agitates or pressurizes the attractant liquid, forcing it toward the outlet 114 in aerosol form. In embodiments where a heating element 150 is installed near the tank, the attractant may be thermally elevated to decrease viscosity and enhance volatilization. In another embodiment, chemical generation of pressure via a reaction between baking soda and vinegar within the tank may be used, in which case no external propellant tank is required. The ability to generate pressurized aerosol internally at the cabinet eliminates the need for discrete aerosolizers at each fixture.

In step 508, the aerosolized attractant mixture is distributed through the system to each of the emitters 136 located in the landscape fixtures. Each emitter is in pneumatic communication with the outlet 114 of the attractant tank via the integrated conduits. As pressurized gas carries the attractant mixture from the central tank, it flows through proportioning valves 144 located proximate each fixture, allowing fine-tuning of dosage levels or complete shut-off of flow to specific units if needed. The emitters release the mixture into the air near the intake region of each fixture, forming a localized attractant cloud. The aerosol attractant may mimic the olfactory profile of lactic acid, octenol, or other mosquito lures and works synergistically with the UV and heat attractants. This combination of visual, thermal, and chemical cues draws pests to the fixture intake zone more reliably than any single attractant modality alone.

In step 510, pests that are attracted to the lighting, heat, and aerosol cues are drawn into the system via the suction port 140 in each landscape fixture. The induction fan 126 located within the central cabinet creates a negative pressure environment within the network of suction lines 142. This negative pressure generates airflow from the suction port through the internal air channels and ultimately into the collection container 122 at the first location (disparate from the location of the fixture at the second location. The vacuum strength may be constant across all fixtures or selectively modulated using the proportioning valves to account for variable distances from the fan or environmental airflow. As insects enter the suction port, they pass through the protective intake screen and are conveyed toward the centralized container for collection.

In step 512, the airflow created by the fan 126 continues through the suction lines and deposits the pests into the collection container 122. The collection container is housed within the central equipment cabinet 104 and is sized to accommodate multiple trapping cycles before requiring service. The use of a centralized collection chamber, rather than independent, distributed pest reservoirs, represents a significant improvement in terms of ease of maintenance, odor control, and hygienic handling. Since the pests are immediately moved away from the visual field of the fixture, it avoids aesthetic degradation and potential buildup of biological residue in sensitive landscaping areas.

At step 514, once the induction fan is deactivated, either through user command or scheduled cycle, the valve 124 at the top of the collection container automatically closes. This valve may be gravity-operated, spring-loaded, or electronically actuated based on airflow cessation. Once closed, the container is sealed from both the suction network and the external environment, trapping pests inside and preventing their escape, secondary infestation, or odor emission. This sealing mechanism minimizes user exposure to collected pests during normal operation and reduces the frequency of emptying. The closed-loop design of the collection, combined with the absence of reservoirs at the fixture level, significantly streamlines the operational lifecycle of the system.

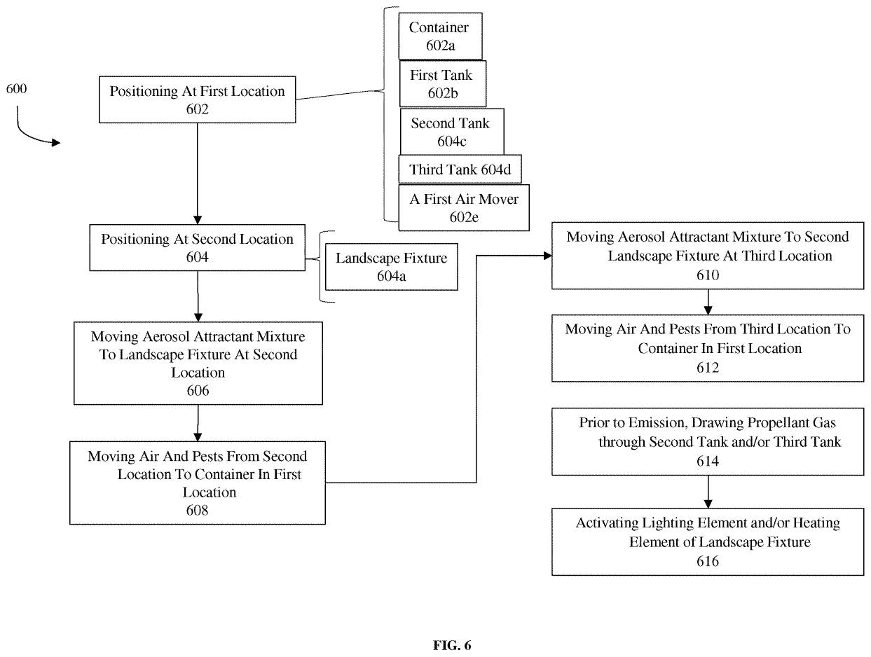

Referring now to FIG. 6, a flowchart diagram illustrating a method controlling pests is shown, according to an example embodiment. The method 600 illustrates a sequence of operations for deploying and operating a distributed landscape nuisance pest control system in which attractants are generated at a first location and emitted from one or more landscape fixtures located at disparate locations, while pests are transported to a centralized container. At step 602, the method includes positioning, at a first location, a container configured to receive and retain nuisance pests, a first tank comprising a propellant gas for attracting pests, a second tank comprising a mixture for attracting hematophagous pests, a third tank comprising a second mixture for attracting oviposition-seeking pests, and a first air mover, wherein the first tank is in fluid communication with the second tank and the third tank. In one example embodiment, these components are housed within a centralized enclosure or service unit. The container 602a may comprise a collection chamber configured to retain captured pests through the use of internal screens, one-way airflow passages, or other retention structures. The first tank 602b may store a propellant gas, such as carbon dioxide, which may simulate biological respiration cues associated with host organisms. The second tank 604c may store a first attractant mixture configured to attract hematophagous pests, while the third tank 604d may store a second attractant mixture configured to attract oviposition-seeking pests. Fluid communication between the first tank and the second and third tanks may be established through conduits and flow control devices such as valves or regulators, enabling the propellant gas to pass through one or more attractant mixtures. The first air mover 602e, which may comprise an induction fan or other airflow-generating device, is positioned at the first location and is configured to generate suction through the conduit network extending to remote landscape fixtures.

At step 604, the method includes positioning, at a second location, a landscape fixture, wherein the second location is disparate from the first location. In one example embodiment, the landscape fixture 604a is installed within a landscape environment such as a yard, garden, park, or other monitored outdoor area where nuisance pests are likely to be present. The landscape fixture is placed in fluid and pneumatic communication with the components positioned at the first location through a plurality of conduits. These conduits may be routed underground, along structural elements, or otherwise integrated into the landscape to transport attractant mixtures and airflow between the first location and the landscape fixture.

At step 606, the method includes moving, using the propellant gas, an aerosol attractant mixture via a conduit to the landscape fixture at the second location such that the aerosol attractant mixture is emitted at the second location. In one example embodiment, the propellant gas from the first tank is directed through the second tank such that the gas entrains or mixes with the attractant mixture stored therein. This interaction generates an aerosol attractant mixture that is transported through a conduit toward the landscape fixture positioned at the second location. The landscape fixture includes an emitter configured to release the aerosol attractant mixture into the surrounding environment. The emitted mixture disperses locally and generates chemical cues that attract nuisance pests, such as mosquitoes.

At step 608, the method includes moving, using the first air mover, air and pests from the second location to the container in the first location. In this step, the first air mover generates negative pressure within the conduit connected to the landscape fixture. This suction draws air from the vicinity of the landscape fixture through an intake or suction port of the fixture and into the conduit network. As pests are attracted to the fixture by the aerosol attractant mixture, they enter the airflow stream and are transported through the conduit toward the container positioned at the first location. Upon reaching the container, the pests are retained within the container by internal retention structures that inhibit escape.

At step 610, the method may further include moving, using the propellant gas, the aerosol attractant mixture via a second conduit to a second landscape fixture at a third location that is disparate from the first location and the second location such that the aerosol attractant mixture is emitted at the third location. In one example embodiment, the conduit network branches to supply multiple landscape fixtures positioned throughout a landscape environment. The propellant gas carrying the attractant mixture is directed through the second conduit to the second landscape fixture, where the mixture is emitted into the surrounding environment to attract pests at the third location.

At step 612, the method includes moving, using the first air mover, air and pests from the third location to the container in the first location. Similar to the operation associated with the second location, suction generated by the first air mover draws air and attracted pests from the second landscape fixture through the conduit network and toward the container at the first location. The pests are transported through the conduit and ultimately captured within the container. In certain embodiments, when additional suction is needed, an additional air mover may between the second location and the first location to assist with moving the target pests and medium from the fixture at the second location to the first location.

At step 614, the method may further include prior to emission at the second location and the third location, drawing the propellant gas through at least one of the second tank and the third tank such that the propellant gas mixes with at least one of the first mixture and the second mixture to form the aerosol attractant mixture. In one example embodiment, valves or other fluid control mechanisms selectively route the propellant gas through the second tank or the third tank depending on the desired attractant formulation. This selective routing allows the system to generate different aerosol attractant mixtures tailored to different pest behavioral states, such as host-seeking or oviposition-seeking behavior.

At step 616, the method may additionally include activating at least one of a lighting element and a heating element of the landscape fixture to increase attraction of nuisance pests. In one example embodiment, the lighting element may comprise an LED or other illumination device configured to produce light wavelengths that attract insects. The heating element may generate localized thermal cues that simulate the body heat of a host organism. When combined with the emitted aerosol attractant mixture and airflow generated by the first air mover, these additional stimuli increase the probability that pests will approach the landscape fixture and be entrained in the airflow stream leading to the container at the first location.

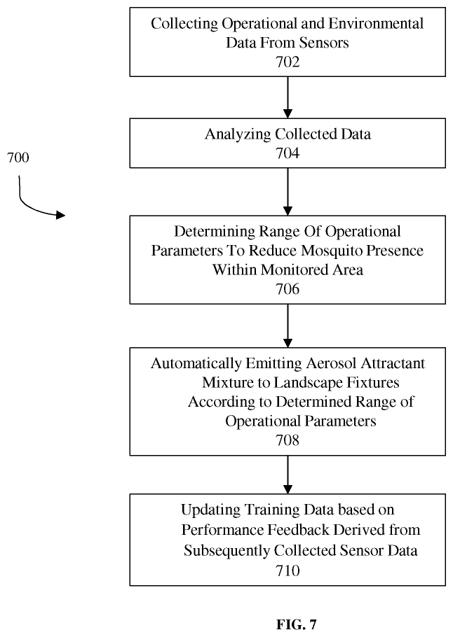

Referring now to FIG. 7, a flowchart diagram illustrating a method 700 of controlling pests using adaptive system control is shown, according to an example embodiment. The method 700 illustrates a sequence of operations in which operational and environmental data collected from sensors distributed throughout the landscape nuisance pest control system are analyzed and used to automatically control emission of attractants and update system training data. At step 702, the method includes collecting operational and environmental data from a plurality of sensors and storing that data in a record (which are created in the attached database) and storing in an attached database. In one example embodiment, the sensors are distributed throughout the landscape nuisance pest control system, including within one or more landscape fixtures, conduits, or centralized system components. The sensors may include environmental sensors configured to detect parameters such as temperature, humidity, wind conditions, atmospheric pressure, and ambient light levels, as well as pest detection sensors configured to detect the presence or activity of nuisance pests. Additional sensors may monitor system operational conditions, including airflow rates, attractant flow rates, tank levels, power status, or container fill levels. The collected data is transmitted from the sensors to a processor associated with the system for further evaluation and the collected data and analysis may be stored in the connected database.

At step 704, the method includes analyzing, using a processor, the collected data. In one example embodiment, the processor receives sensor data, or retrieves the data from the attached databaseand evaluates the data in view of historical operational information and environmental conditions stored within a memory. The processor may execute programmed algorithms or data processing routines configured to interpret the incoming sensor signals and determine patterns associated with pest activity or environmental conditions that influence pest behavior. In certain embodiments, the processor may reference training data stored in memory of the connected database, where the training data may include historical operational data, real-time operational data, environmental condition data, pest detection data, and attractant deployment performance data.

At step 706, the method includes determining a range of operational parameters for at least one of the first tank, the second tank, the first air mover, the second air mover, and the landscape fixture to reduce a mosquito presence within a monitored area. In one example embodiment, the processor determines appropriate operating conditions for the system based on the analyzed data. These operational parameters may include, for example, the timing or duration of aerosol attractant emission, the flow rate of propellant gas through one or more attractant tanks, the airflow rate generated by the air movers, activation of lighting or heating elements of the landscape fixtures, or the selection of particular attractant mixtures. The determined range of operational parameters may be selected to correspond with predicted mosquito activity levels or environmental conditions conducive to mosquito presence.

At step 708, the method includes automatically emitting the aerosol attractant mixture to at least one of the first landscape fixture and the second landscape fixture according to the determined range of operational parameters. In one example embodiment, the processor transmits control signals to system components that regulate the movement of propellant gas and attractant mixtures through the conduit network. The aerosol attractant mixture is emitted from one or more landscape fixtures positioned throughout the monitored area in accordance with the determined operational parameters. The coordinated operation of the attractant emission and airflow generation components encourages pests to approach the landscape fixtures and be entrained within the airflow directed toward the centralized container.

At step 710, the method further includes updating training data based on performance feedback derived from subsequently collected sensor data. In one example embodiment, the processor evaluates sensor data collected after system deployment to determine the effectiveness of the operational parameters that were previously implemented. Performance feedback may include observed pest capture rates, detected pest activity levels, environmental changes, or other system performance indicators. This feedback is used to update the stored training data so that future analyses performed by the processor may more accurately predict pest behavior and determine improved operational parameters for subsequent system operation. Through this iterative updating process, the system may continuously refine its control strategies to improve pest reduction within the monitored area.

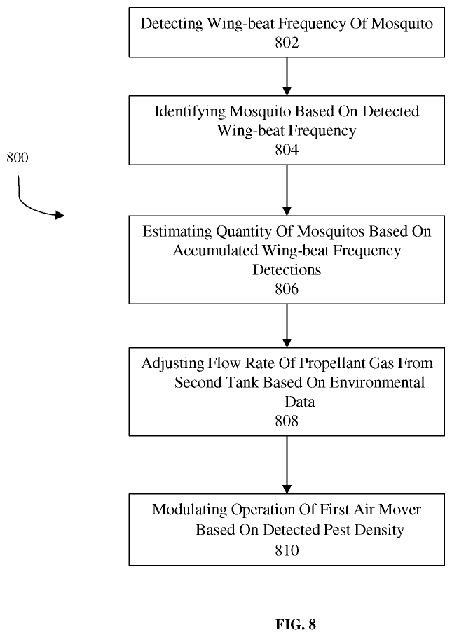

Referring now to FIG. 8, a flowchart diagram illustrating a method of controlling pests using sensor-based pest detection and adaptive system control is shown, according to an example embodiment. The method 800 illustrates a sequence of operations in which sensor data relating to mosquito wing-beat frequency is used to identify pests, estimate pest density, and dynamically adjust operation of system components. At step 802, the method includes detecting, using at least one sensor disposed at the second location, a wing-beat frequency of a mosquito. In one example embodiment, the sensor is positioned within or adjacent to a landscape fixture located at the second location of the pest control system. The sensor may comprise an optical sensor, acoustic sensor, laser-based detection device, or other sensing apparatus capable of detecting periodic motion associated with insect wing movement. As mosquitos or other insects pass through the sensing region, the sensor detects oscillatory signals corresponding to wing movement and generates data representing the measured wing-beat frequency. The detected wing-beat frequency signals are transmitted to a processor associated with the pest control system.

At step 804, the method includes identifying, using the processor, the mosquito based on the detected wing-beat frequency. In one example embodiment, the processor receives the wing-beat frequency data generated by the sensor and compares the detected frequency signature to stored reference data corresponding to known insect wing-beat frequencies. Because different insect species exhibit characteristic wing-beat frequency ranges, the processor may analyze the detected signal and determine whether the detected insect corresponds to a mosquito or another type of insect. This identification process may involve filtering the sensor data, extracting frequency components, and comparing the resulting values to stored frequency ranges associated with target pest species.

At step 806, the method includes estimating a quantity of mosquitos based on accumulated wing-beat frequency detections. In one example embodiment, the processor aggregates wing-beat detection events recorded by the sensor over a defined time interval. Each detection corresponding to a mosquito wing-beat signature may be counted or otherwise recorded to estimate the relative abundance of mosquitos within the monitored area. The processor may maintain a running total or statistical model representing mosquito activity levels at the second location. This accumulated data enables the system to determine an estimated pest density or activity level over time.

At step 808, the method includes adjusting, using the processor, a flow rate of the propellant gas from the second tank based on environmental data. In one example embodiment, the processor evaluates environmental data collected from sensors distributed throughout the pest control system, such as temperature, humidity, wind conditions, or atmospheric pressure. Based on this environmental data, the processor may adjust the flow rate of the propellant gas delivered from the second tank so as to regulate the emission rate of an aerosol attractant mixture. For example, increased attractant emission may be deployed during environmental conditions that correspond with increased mosquito activity, while reduced emission may be used during conditions that are less conducive to mosquito presence.

At step 810, the method includes modulating, using the processor, operation of the first air mover based on a detected pest density. In one example embodiment, the processor determines the pest density based on the estimated mosquito quantity derived from accumulated wing-beat detections. The processor may then adjust operational parameters of the first air mover, such as fan speed or airflow intensity, in response to the detected pest density. For example, when mosquito activity is elevated, the processor may increase airflow to improve capture efficiency and transport pests toward the centralized container. Conversely, when pest activity is low, the processor may reduce airflow to conserve energy while maintaining system readiness. Through this adaptive control of airflow and attractant emission, the system dynamically responds to real-time pest activity conditions within the monitored area.

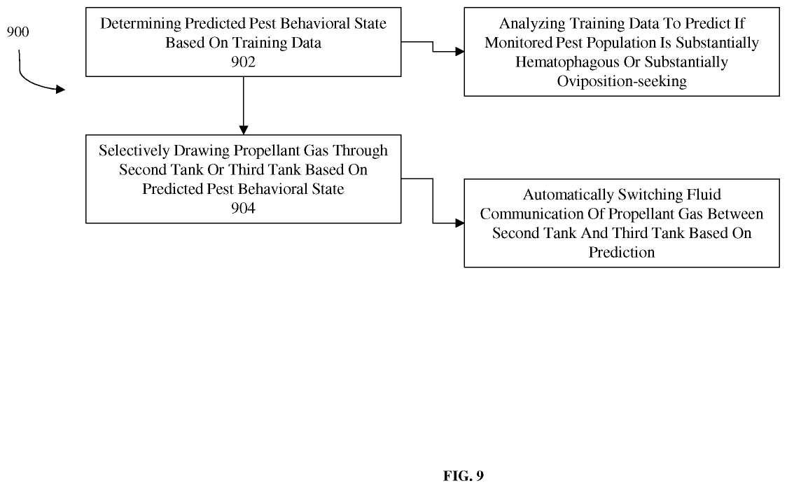

Referring now to FIG. 9, a flowchart diagram illustrating a method of controlling pests using predictive pest behavioral analysis is shown, according to an example embodiment. The method 900 illustrates a sequence of operations in which a processor analyzes training data to predict pest behavioral states and selectively deploys attractant mixtures accordingly. At step 902, the method includes determining, using the processor, a predicted pest behavioral state based on the training data. In one example embodiment, the processor accesses training data stored in a memory associated with the landscape nuisance pest control system. The training data may include historical operational data, environmental condition data, pest detection data, attractant deployment performance data, and other information collected during prior system operation. As part of determining the predicted pest behavioral state, the processor analyzes the training data to predict if a monitored pest population is at least one of substantially hematophagous and substantially oviposition-seeking. For example, the processor may evaluate environmental conditions such as temperature, humidity, time of day, or seasonal patterns in combination with previously recorded pest activity levels to determine whether mosquitos in the monitored area are more likely to be host-seeking or oviposition-seeking at a given time.

At step 904, the method includes selectively drawing the propellant gas through one of the second tank or the third tank based on the predicted pest behavioral state. In one example embodiment, the processor controls one or more valves or flow-control devices within the fluid network connecting the propellant gas source to the attractant tanks. Based on the predicted pest behavioral state determined at step 902, the processor selectively routes the propellant gas through the tank containing the attractant mixture that corresponds with the predicted pest behavior. In particular, the processor may automatically switch fluid communication of the propellant gas between the second tank and the third tank based on the prediction, thereby causing the propellant gas to mix with the selected attractant mixture and generate an aerosol attractant mixture suited to the predicted behavioral state of the pest population. The resulting aerosol attractant mixture is then delivered to one or more landscape fixtures for emission into the monitored environment.

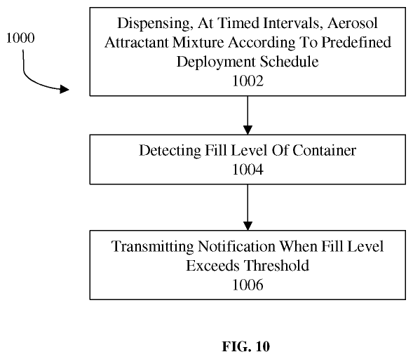

Referring now to FIG. 10, a flowchart diagram illustrating a method of controlling pests using scheduled attractant deployment and container monitoring is shown, according to an example embodiment. The method 1000 illustrates a sequence of operations corresponding to the method steps described in claim 22, in which the system dispenses attractants according to a schedule and monitors a pest collection container to determine when servicing may be required.

At step 1002, the method includes dispensing, at timed intervals, the aerosol attractant mixture according to a predefined deployment schedule. In one example embodiment, a processor associated with the landscape nuisance pest control system executes a deployment schedule stored within a memory. The predefined deployment schedule may specify particular time intervals, durations, or environmental conditions during which the aerosol attractant mixture is to be emitted from one or more landscape fixtures. The processor may transmit control signals to valves, regulators, or other flow-control components that permit propellant gas from a tank to pass through one or more attractant tanks, thereby forming an aerosol attractant mixture that is delivered through conduits to the landscape fixtures. The landscape fixtures then emit the aerosol attractant mixture into the surrounding environment at the specified intervals to attract nuisance pests toward the fixtures.

At step 1004, the method includes detecting a fill level of the container. In one example embodiment, a sensor associated with the container monitors the accumulation of pests captured within the container. The sensor may comprise, for example, an optical sensor, weight sensor, capacitive sensor, or other level-detection mechanism capable of determining the relative quantity of pests retained within the container. The detected fill level information is transmitted to the processor so that the system can determine whether the container is approaching a capacity limit.

At step 1006, the method includes transmitting a notification when the fill level exceeds a threshold. In one example embodiment, the processor compares the detected fill level of the container with a predetermined threshold value stored in memory. When the detected fill level exceeds the threshold, the processor generates a notification indicating that the container may require servicing or emptying. The notification may be transmitted to a user device, service platform, or remote monitoring system via a communication interface associated with the pest control system. In certain embodiments, the notification may comprise a message transmitted to a mobile device, a maintenance scheduling system, or a remote monitoring dashboard to alert a user that the container has reached or exceeded the threshold fill level.

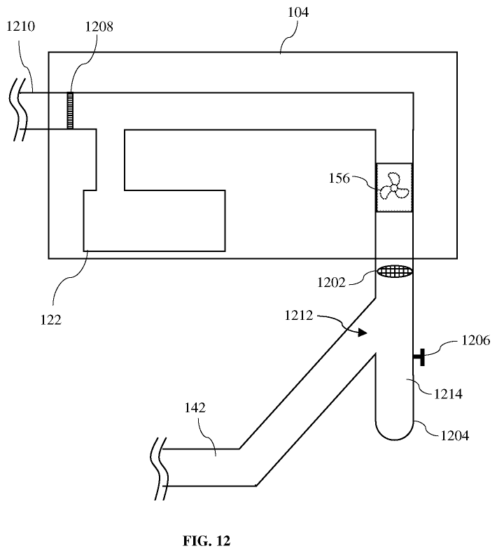

Referring now to FIG. 12, an example embodiment of a portion of the landscape nuisance pest control system configured to reduce bycatch of non-target insects and to maintain airflow through the system is shown. The illustrated configuration shows the centralized cabinet 104 in fluid communication with a conduit 142 and an intake region 1202, with airflow generated by an air mover 156. Airflow from the landscape fixtures through the conduit 142 is directed upward into the centralized cabinet 104 rather than directly inward across a horizontal intake surface. This upward-directed suction alters the interaction between incoming insects and the intake region such that lighter target pests, such as mosquitos, are more readily entrained in the airflow stream, while larger non-target insects are less likely to become lodged against intake surfaces. By directing airflow upward, the system reduces accumulation of bycatch insects that would otherwise adhere to a screen and obstruct airflow. The intake region 1202 includes one or more openings sized to permit ingress of target pests while reducing blockage associated with larger insects or debris. In one example embodiment, the intake region 1202 may include a coarse screen or filter having relatively larger openings that allow airflow to pass with reduced resistance. A secondary screen 1208 having smaller openings may be positioned upstream within the cabinet 104 to provide additional filtration to block smaller or target pests from moving into the exhaust conduit 1210. The combination of a larger opening intake region and a secondary finer screen allows the system to capture smaller target pests while reducing the likelihood that larger insects will block the primary intake surface. As airflow progresses through the system, insects entrained in the airflow may be conveyed toward an internal collection region within the cabinet 104. Larger insects that are not fully entrained in the airflow may remain near the filter 1202 or intermediate portions of the conduit network. To address this, the system further includes a valve 1206 in communication with a collection portion 1204 of the conduit pathway. The lower portion 1204 may function as a collection tray or drop zone for non-target insects.

The valve 1206 may be selectively actuated to alter pressure conditions within the conduit network. For example, when the valve 1206 is opened or when suction generated by the air mover 156 is reduced or temporarily stopped, airflow through the conduit decreases, thereby reducing the forces holding insects against the intake region 1202 or other surfaces. In this condition, larger non-target insects, such as moths, may fall away from the intake region due to gravity and may drop into the lower portion 1204, which may comprise a collection tray or receptacle. The interaction of the upward-directed suction, the multi-stage intake and screening configuration, and the selectively operable valve 1206 allows the system to reduce clogging caused by bycatch insects while maintaining effective capture of target pests. In operation, the system may periodically actuate the valve 1206 or modulate airflow to clear accumulated insects, thereby maintaining airflow efficiency and reducing maintenance requirements associated with blocked intake screens.

A challenge associated with pest collection systems includes the unintended capture of non-target insects, commonly referred to as bycatch, such as moths or other larger flying insects. These non-target insects may become lodged against intake screens or filter surfaces positioned at or near the landscape fixture or within the airflow pathway. As a result, accumulation of such insects can obstruct airflow through the system, thereby reducing suction efficiency and impairing the ability of the system to draw in target pests. This obstruction may lead to decreased overall system performance and increased maintenance requirements to clear blocked intake regions. By addressing the accumulation of bycatch insects and mitigating blockage of airflow pathways, the system improves operational efficiency and enhances selective capture of target pests, such as mosquitos, while reducing unintended impact on non-target insect populations. This configuration supports environmental considerations by limiting unnecessary capture of beneficial or non-target insects and maintaining effective airflow conditions for improved target insect capture.

In some embodiments, this conduit and intake configuration may be arranged in an upside-down Y-shaped configuration in which the filter 1202 is positioned along an upper branch and a lower branch terminates at a collection tray 1204. In this configuration, airflow generated during operation is directed through the upper branch toward the centralized cabinet, while the lower branch provides a gravitational drop path for non-target insects. When suction is reduced or discontinued, such as when the air movers are deactivated or the valve is opened, gravity acts on bycatch insects positioned at or near the intake region 1202. Larger insects that are not fully entrained within the airflow may fall downward through the lower branch of the inverted Y-shaped conduit and collect within the tray 1204. In this manner, the geometry of the conduit utilizes gravity to separate and remove bycatch insects from the intake region without requiring additional mechanical components. This configuration allows the intake region 1202 to remain relatively clear of obstructions while enabling non-target insects to be passively collected within the tray 1204 for subsequent removal.

Shown in the embodiment in FIG. 12, the landscape nuisance pest control system is configured to mitigate airflow obstruction caused by bycatch insects, such as moths and other larger non-target insects, through use of a conduit arrangement incorporating a Y-shaped fitting disposed beneath the air mover within the centralized cabinet. Generally, bycatch insects may become lodged against upstream screens or intake structures, thereby reducing airflow and impairing system performance. To address this condition, the conduit network includes the Y-shaped junction 1212 in which a first branch leading to conduit 142, oriented at approximately a 45-degree angle, is in communication with one or more landscape fixtures, and a second branch 1214 extends generally downward to define a gravity-assisted collection path.

More specifically, the angled branch of the Y-shaped fitting directs airflow and entrained pests from the landscape fixtures toward the centralized cabinet, while the vertical branch terminates in a collection region positioned below the primary airflow path. The serviceable collection cap or tray 1204 may be disposed at a lower end of the vertical branch and may be spaced from the main airflow stream such that airflow velocity within the vertical branch is reduced relative to the primary flow path. The coarse screen 1202 positioned upstream of the air mover, for example having openings on the order of approximately one-half inch, may intercept larger bycatch insects while allowing smaller target pests to pass through. When airflow is reduced or stopped, gravity acts on the intercepted bycatch insects, causing the bycatch insects to fall downward through the vertical branch of the Y-shaped fitting and into the collection tray.

In certain embodiments, the collection tray or cap may be replaced with an automated discharge mechanism, such as a gate valve or butterfly valve, positioned at the lower end of the vertical branch. The valve may be selectively actuated to open the vertical branch to the surrounding environment, thereby allowing accumulated bycatch insects to exit the system without manual intervention. In further embodiments, the air mover may be configured to operate in a reverse flow mode in conjunction with actuation of the valve. During such operation, airflow is temporarily reversed through the conduit network to assist in dislodging insects from the coarse screen and directing the insects downward through the vertical branch, thereby providing a self-cleaning function.

Downstream of the air mover, the secondary screen 1208 having smaller openings, for example less than approximately three-eighths of an inch, may be positioned proximate the exhaust region 1210. The secondary screen is configured to capture target pests, such as mosquitos, that pass through the air mover 156 while permitting airflow to exit the system. Captured pests may accumulate at the secondary screen and may subsequently fall into the designated collection container 122 or be removed during servicing. Through the interaction of the Y-shaped fitting, the coarse upstream screen, the gravity-assisted collection path, and the downstream fine screen, the system reduces airflow obstruction caused by bycatch insects while maintaining effective capture of target pests.

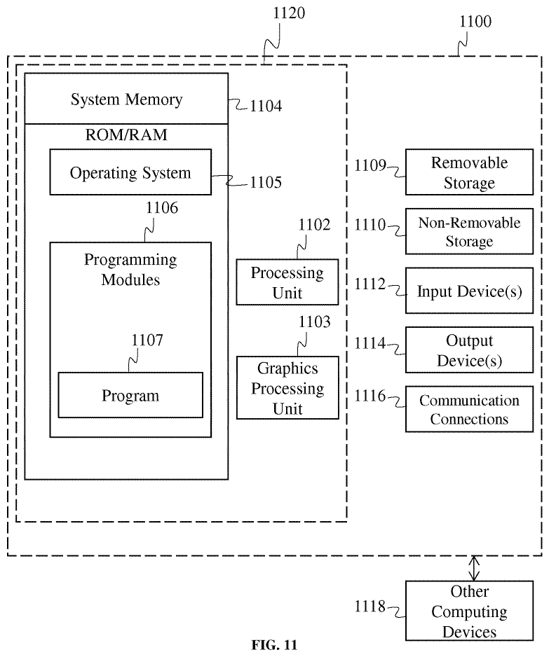

FIG. 11 is a block diagram of a system including an example computing device 1100 and other computing devices. Consistent with the embodiments described herein, the aforementioned actions performed by server 202 or computing device 102 may be implemented in a computing device, such as the computing device 1100 of FIG. 11. Any suitable combination of hardware, software, or firmware may be used to implement the computing device 1100. The aforementioned system, device, and processors are examples and other systems, devices, and processors may comprise the aforementioned computing device. Further-more, computing device 1100 may comprise an operating environment for the methods shown in FIGS. 5 through 10 above.

With reference to FIG. 11, a system consistent with an embodiment of the invention may include a plurality of computing devices, such as computing device 1100. In a basic configuration, computing device 1100 may include at least one processing unit 1102 and a system memory 1104. Depending on the configuration and type of computing device, system memory 1104 may comprise, but is not limited to, volatile (e.g., random access memory (RAM)), nonvolatile (e.g., read-only memory (ROM)), flash memory, or any combination or memory. System memory 1104 may include operating system 1105, one or more programming modules 1106 (such as program module 1107). Operating system 1105, for example, may be suitable for controlling computing device 1100′s operation. In one embodiment, programming modules 1106 may include, for example, a program module 1107. Furthermore, embodiments of the invention may be practiced in conjunction with a graphics library, other operating systems, or any other application program and is not limited to any particular application or system. This basic configuration is illustrated in FIG. 1100 by those components within a dashed line 1120.

Computing device 1100 may have additional features or functionality. For example, computing device 1100 may also include additional data storage devices (removable and/or non-removable) such as, for example, magnetic disks, optical disks, or tape. Such additional storage is illustrated in FIG. 11 by a removable storage 1109 and a non-removable storage 1110. Computer storage media may include volatile and nonvolatile, removable, and non-removable media implemented in any method or technology for storage of information, such as computer readable instructions, data structures, program modules, or other data. System memory 1104, removable storage 1109, and non-removable storage 1110 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information, and which can be accessed by computing device 1100. Any such computer storage media may be part of device 1100. Computing device 1100 may also have input device(s) 1112 such as a keyboard, a mouse, a pen, a sound input device, a camera, a touch input device, etc. Output device(s) 1114 such as a display, speakers, a printer, etc. may also be included. The aforementioned devices are only examples, and other devices may be added or substituted.

Computing device 1100 may also contain a communication connection 1116 that may allow device 1100 to communicate with other computing devices 1118, such as over a network in a distributed computing environment, for example, an intranet or the Internet. Communication connection 1116 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acous-tic, radio frequency (RF), infrared, and other wireless media. The term computer readable media as used herein may include both computer storage media and communication media.

As stated above, a number of program modules and data files may be stored in system memory 1104, including operating system 1105. While executing on processing unit 1102, programming modules 1106 may perform processes including, for example, one or more of the methods shown in FIGS. 5 through 10 above. Computing device 1100 may also include a graphics processing unit 1103, which supplements the processing capabilities of processor 1102 and which may execute programming modules 1106, including all or a portion of those processes and methods shown in FIGS. 5 through 10 above. The aforementioned processes are examples, and processing units 1102, 1103 may perform other processes. Other program-ming modules that may be used in accordance with embodi-ments of the present invention may include electronic mail and contacts applications, word processing applications, spreadsheet applications, database applications, slide presentation applications, drawing or computer aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configura-tions, including handheld devices, multiprocessor systems, microprocessor based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be prac-ticed in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general-purpose computer or in any other circuits or systems.

Embodiments of the present invention, for example, are described above with reference to block diagrams and/or operational illustrations of methods, systems, and computer program products according to embodiments of the inven-tion. The functions/acts noted in the blocks may occur out of the order as shown in any flowchart. For example, two blocks shown in succession may in fact be executed substantially concurrently or the blocks may sometimes be executed in the reverse order, depending upon the function-ality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A landscape nuisance pest control system comprising:
a container;
a first tank comprising a gas for attracting pests;
a first air mover;
a first location housing the container, the first tank, and the first air mover;
a landscape fixture located at a second location disparate from the first location; and
wherein each of the landscape fixture and the first tank, the first air mover are in communication by a plurality of conduits.

2. The landscape nuisance pest control system of claim 1, wherein the first location further houses a second tank comprising a mixture for attracting pests; and
wherein the first tank in fluid communication with the second tank.

3. The landscape nuisance pest control system of claim 2, further comprising a processor at the first location that monitors and controls operations of the landscape nuisance pest control system based on input received from at least one of a plurality of sensors corresponding disposed throughout the landscape nuisance pest control system.

4. The landscape nuisance pest control system of claim 3 wherein the landscape fixture comprises:
a mounting base comprising an electrical connection, a pneumatic connection, and a protective intake screen;
a suction port disposed on the landscape fixture and in communication with the container via a first conduit of the plurality of conduits;
a lighting element;
at least one of a second light element and a heating element;
an emitter in communication with at least one of the first tank and the second tank by a second conduit of the plurality of conduits, the emitter comprising an aerosol attractant mixture dispensable from the first location; and
a first sensor of the plurality of sensors, the first sensor is configured to provide a signal to the processor.

5. The landscape nuisance pest control system of claim 4, wherein the first conduit comprises a second air mover for assisting suction from the landscape fixture to the container.

6. The landscape nuisance pest control system of claim 2, wherein the first location further comprises a power supply element in electrical communication with the landscape fixture and at least one of the first tank, the second tank, and the first air mover.

7. The landscape nuisance pest control system of claim 1, wherein the gas comprises CO2.

8. The landscape nuisance pest control system of claim 1, wherein the first air mover is an induction fan.

9. The landscape nuisance pest control system of claim 3, wherein the processor is configured to:
collect operational and environmental data from the plurality of sensors;
analyze the collected data using training data stored in a memory;
determine a range of operational parameters for at least one of the first tank, the second tank, the first air mover, and the landscape fixture to reduce a mosquito presence within a monitored area;
automatically deploy the landscape nuisance pest control system according to the determined range of operational parameters; and
update the training data based on performance feedback derived from subsequently collected sensor data.

10. A landscape nuisance pest control system comprising:
a container;
a first tank comprising a gas for attracting pests;
a second tank comprising a mixture for attracting pests;
the first tank in fluid communication with the second tank;
a first air mover comprising an induction fan;
a second air mover;
a first location housing the container, the first tank, the second tank, the first air mover, and the second air mover;
a landscape fixture located at a second location disparate from the first location;
a processor disposed at the first location; and
a plurality of sensors disposed throughout the landscape nuisance pest control system and in communication with the processor;
wherein each of the landscape fixture and the first tank, the second tank, the first air mover, and the second air mover are in communication by a plurality of conduits;
wherein the second air mover is disposed within a first conduit of the plurality of conduits and is configured to assist suction from the landscape fixture to the container; and
wherein the processor is configured to monitor and control operations of the landscape nuisance pest control system based on input received from at least one of the plurality of sensors.

11. The landscape nuisance pest control system of claim 10, wherein the landscape fixture comprises:
a mounting base comprising an electrical connection, a pneumatic connection, and a protective intake screen configured to permit ingress of target pests while restricting passage of non-target debris;
a suction port disposed on the landscape fixture and in communication with the container via the first conduit of the plurality of conduits;
a lighting element configured to provide illumination;
at least one of a second light element and a heating element configured to attract nuisance pests;
an emitter in communication with at least one of the first tank and the second tank by a second conduit of the plurality of conduits, the emitter being configured to dispense an aerosol attractant mixture originating from the first location; and
a first sensor of the plurality of sensors, the first sensor configured to provide a signal to the processor.

12. The landscape nuisance pest control system of claim 10, wherein at least one sensor of the plurality of sensors comprises:
a wing-beat frequency sensor configured to detect a wing frequency of a mosquito and to generate data corresponding to a quantity of mosquitos based on detected wing frequency signatures.

13. The landscape nuisance pest control system of claim 10, wherein the mixture comprises a plurality of ingredients for attracting hematophagous pests, and the gas comprises CO2.

14. The landscape nuisance pest control system of claim 10, wherein the mixture comprises a plurality of ingredients for attracting oviposition-seeking pests, and the gas comprises CO2.

15. The landscape nuisance pest control system of claim 10, wherein the first location further comprises a power supply element in electrical communication with the landscape fixture and at least one of the first tank, the second tank, the first air mover, and the second air mover.

16. The landscape nuisance pest control system of claim 10, wherein the processor is further configured to:
collect operational and environmental data from the plurality of sensors;
analyze the collected data using training data stored in a memory;
determine a range of operational parameters for at least one of the first tank, the second tank, the first air mover, the second air mover, and the landscape fixture to reduce a mosquito presence within a monitored area;
automatically deploy the landscape nuisance pest control system according to the determined range of operational parameters; and
update the training data based on performance feedback derived from subsequently collected sensor data.

17. A method of controlling pests comprising:
positioning, at a first location,
a container configured to receive and retain nuisance pests;
a first tank comprising a propellant gas for attracting pests;
a second tank comprising a first mixture for attracting hematophagous pests, wherein the first tank is in fluid communication with the second tank;
a third tank comprising a second mixture for attracting oviposition-seeking pests, wherein the first tank is in fluid communication with the third tank;
a first air mover;
a first location housing the container, the first tank, the second tank, and the first air mover;
positioning, at a second location, a landscape fixture;
wherein the second location is disparate from the first location;
wherein each of the landscape fixture and the first tank, the second tank, the first air mover are in communication by a plurality of conduits;
moving, using propellant gas, an aerosol attractant mixture via a conduit to the landscape fixture at the second location such that the aerosol attractant mixture is emitted at the second location; and,
moving, using the first air mover, air and pests from the second location to the container in the first location.

18. The method of controlling pests of claim 17 further comprising:
moving, using propellant gas, the aerosol attractant mixture via a second conduit to a second landscape fixture at a third location that is disparate from the first location and the second location such that the aerosol attractant mixture is emitted at the third location; and,
moving, using the first mover, air and pests from the third location to the container in the first location;
prior to emission at the second location and the third location, drawing the propellant gas through at least one of the second tank and the third tank such that the propellant gas mixes with at least one of the first mixture and the second mixture to form the aerosol attractant mixture; and
activating at least one of a lighting element and a heating element of the landscape fixture to increase attraction of nuisance pests.

19. The method of claim 18, wherein the method further comprising:
collecting operational and environmental data from a plurality of sensors;
analyzing, using a processor, the collected data;
determining a range of operational parameters for at least one of the first tank, the second tank, the first air mover, the second air mover, and the landscape fixture to reduce a mosquito presence within a monitored area;
automatically emitting the aerosol attractant mixture to at least one of the first landscape fixture and the second landscape fixture according to the determined range of operational parameters;
updating training data based on performance feedback derived from subsequently collected sensor data;
wherein training data comprises at least one of historical operational data, real-time operational data, environmental condition data, pest detection data, and attractant deployment performance data.

20. The method of claim 19 further comprising:
determining, using the processor, a predicted pest behavioral state based on the training data;
selectively drawing the propellant gas through one of the second tank or the third tank based on the predicted pest behavioral state;
analyzing, using the processor, the training data to predict if a monitored pest population is at least one of a substantially hematophagous and substantially oviposition-seeking; and
automatically switching fluid communication of the propellant gas between the second tank and the third tank based on the prediction.
